(19) United States
(12) Patent Application Publication
(10) Pub. No.: US 2010/0153278 A1
(43) Pub. Date: Jun. 17, 2010

(54) WEB SITES THAT INTRODUCE A SELLER TO A UNIVERSE OF BUYERS, WEB SITES THAT RECEIVE A BUYER'S LISTING OF WHAT HE WANTS TO BUY, OTHER INTRODUCTION WEB SITES, SYSTEMS USING INTRODUCTION WEB SITES AND INTERNET-BASED INTRODUCTIONS

(76) Inventor: Lewis E. Farsedakis, Boca Raton, FL (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/486,398

(22) Filed: Jun. 17, 2009

Related U.S. Application Data
(63) Continuation of application No. 61/122,992, filed on Dec. 16, 2008.

(51) Int. Cl. G06Q 30/00; G06Q 10/00; G06Q 50/00; G06F 17/30; G06F 17/40

(52) U.S. Cl. 705/80; 705/26; 705/27; 705/10; 707/E17.014; 707/E17.044

(57) ABSTRACT

An inventive website is used by a seller to find a universe of buyers, and by a buyer to be introduced to a seller without investing much time. The website in-takes a user's description of his target item with agreeable price, which gets posted on the website. When a seller encounters a posting for which he wants to be introduced to the poster, he has the system report his interest to the poster and once the poster grants permission, the seller can be introduced to, and directly email, telephone, etc. the poster. The provision of the introduction can be conditioned upon payment by the seller or otherwise. An Identity Scoring system outputs a score indicating the likelihood that the opposite party actually is who claims to be.

### RELATED APPLICATION

This application claims benefit of U.S. provisional application No. 61/122,992 filed Dec. 16, 2008 titled “Web-based introductions” by Lewis E. Farsedakis.

### FIELD OF THE INVENTION

This invention relates to the Internet, more particularly to web sites that sellers visit, especially web sites that sellers visit to find buyers.

### BACKGROUND OF THE INVENTION

The Internet is a relatively recent development, with the existence of websites (such as Ebay, Amazon, Priceline) that bring together buyers and sellers in various ways being even more recent. There remain unmet needs on the part of buyers and sellers, respectively.

A favorite website of sellers using the Internet is Ebay, yet Ebay-based selling requires the seller to invest his time to describe and post an item for sale usually including creating and uploading at least one digital photograph. Despite all this work, the seller's item may go unsold, or the seller's item may sell to the actual for less than a willing buyer who was not participating would have paid.

From a buyer's perspective, shopping via the Internet has certain complications and disadvantages. The buyer may have to invest too much time before he gets to a point where he actually purchases his target item, or may not find the target item at the desired price even after investing a large amount of time searching and negotiating. For example, in one approach a buyer enters a query for the target item into a search engine and reviews the returned responses. That approach tends to only work for a relatively limited group of items, such as current book titles, while being unworkable or overly time-consuming for most target purchases. Another approach that buyers use is to browse Ebay, but browsing on Ebay for a target purchase uses the buyer's time, and the target item may or may not be located at the desired price as an immediately-purchasable item, and if located in the form of an auction and bid upon, the buyer may or may not be the winning bidder. A buyer using Ebay therefore often invests a substantial amount of his time without securing the target item. Moreover, many people are leery of purchasing from a stranger over the Internet such as via Ebay, no matter how good the seller's ratings are, especially for purchases that are time-sensitive or are high-cost for that buyer.

### SUMMARY OF THE INVENTION

The present inventor has considered the above shortcomings of the prior art, and provides an automated, Internet-based introduction service in which a seller is introduced to a universe of buyers of what the seller is selling, through the performance of automated, computer-based steps. A stream of revenue is generated by monetizing the buyer-seller introduction, such as by conditioning the seller's being put in contact with the buyer upon the seller's making a payment.

It is an object of the invention to introduce a buyer to a seller, with the introduction being accomplished through steps performed by a computer, computer network or machine.

It further is an object of the invention to derive revenue from making a computer-implemented introduction between a buyer and a seller.

It will be appreciated that the invention, by providing for use of a website, provides for a buyer or a seller to have access to a global array of opposite parties. The invention is a preferred embodiment provides a website which operates to introduce buyers and sellers to permit them to form a globalized marketplace. The invention exploits the freedom of a buyer to set the price that he is willing to pay for a target item (such as a product, a service, an experience, real estate, an animal, intellectual property, a business, etc.) for the world to see.

In one preferred embodiment, the invention provides a method of introducing at least one Buyer to at least one Seller, comprising the steps of: via a website, in-taking from the Buyer, in computer-readable form, at least a description of a target item and a price (such as, e.g., a firm non-negotiable price; a negotiable price; etc.) that the Buyer is willing to pay for the target item; generating an entry for the target item of the Buyer; posting the entry (such as, e.g., posting an entry that includes a geographical location of the Buyer) for the target item of the Buyer on the website, the website being viewable by the Seller; introducing the Buyer to the Seller; wherein each step is performed by one or more of: a computer, a computer processor, a computer network, a machine or another non-human instrumentality, or a combination thereof, such as, e.g., inventive methods including steps performed by the automated system and before the introducing step of: via the website, in-taking a search query that was input by the Seller at an input time, and returning to the Seller, within seconds of the input time, a list comprising the entry for the target item of the Buyer or a link thereto and, optionally, comprising one or more further entries or further links to entries respectively generated from a plurality of Buyers; inventive methods further comprising, for a claimed identity (of a party who is the Buyer or the Seller) in-taken by the website as input from the party, cross-referencing the claimed identity; inventive methods wherein each step is performed by an automated system which further performs a step of computing an Identity Rating; inventive methods which include a step of displaying a computed Identity Rating for a party to an opposite party; inventive methods including, receiving as input from the Buyer a photograph (and optionally a comment regarding price flexibility and/or location of the Buyer and/or other comment); inventive methods including, after charging the Seller, an introducing step including providing to the Seller a contact information for the Buyer; inventive methods including a step of collecting compensation before the introducing step; inventive methods in which introducing of respective buyer-seller pairs is accomplished on a global basis between a pool of buyers that is global and a pool of sellers that is global; inventive methods including the website's in-taking, from a plurality of respective Buyers, descriptions for target items in a plurality of languages and/or alphabets, while also in-taking, from a plurality of respective Sellers, search queries in a plurality of languages and/or alphabets; inventive methods including a step of displaying a computed Identity Rating for at least one of the Buyer and the Seller to an opposite party who is being introduced or has been introduced to the party for whom the Identity Rating was computed; inventive methods including repeating the Buyer-Seller introducing step for a plurality of Buyer-Seller introductions, wherein the website operates on a global basis and the Buyer-Seller introductions are on a global basis; inventive methods including computing an Identity Rating for the Buyer, computing an Identity Rating for the Seller, displaying to the Buyer the Identity Rating for the Seller, and displaying to the Seller the Identity Rating for the Buyer; inventive methods wherein the computing of the Identity Rating includes processing cross-reference data from at least a first source and a second source, the first source representing information on the Internet that the user being rated may self-post or information that the user being rated may upload, and the second source representing information on the Internet not self-posted by the user being rated; inventive methods that include a step performed by the automated system of receiving, in machine-readable form, input relating to verification that is physically-based and/or in-person by a Notary or other verifier, with regard to an identity of the user for whom an Identity Rating is being computed, followed by computing the Identity Rating using the received input relating to verification; inventive methods that include (without charge to the Seller): receiving a search query from the Seller, processing the Seller's search query and returning to the Seller search results for at least the Buyer in which a location for each Buyer is displayed in the search results returned to the Seller; inventive methods including performing the steps of in-taking from the Buyer the description of the target item and the price, generating and posting the entry on the website, and introducing the Buyer to the Seller, without charging the Buyer; inventive methods including, without charge to the Seller, saving, in a database, a search query input by a Seller to which search query no entry for a target item of a Buyer was returned, followed by computer-based processing of the saved search query in the database against newly-in-taken Buyer entries, and, if the processor determines that a new Buyer entry is responsive to the Seller's saved search query, automatically notifying the Seller of the new Buyer entry optionally including notifying of a percentage match of the new Buyer entry vis-a-vis the Seller's saved search query; inventive methods including performing the steps of in-taking from the Buyer the description of the target item and the price, generating and posting the entry on the website, and introducing the Buyer to the Seller, without charging the Buyer; inventive methods wherein the in-taking from the Buyer the description of the target item and the price, and generating the entry and posting the entry are performed without being conditioned on collecting compensation from the Buyer or the Seller, and further including a step by the automated system of providing access to the Seller to view the posted entry for the target item without providing access being conditioned on collecting compensation from the Buyer or the Seller, and further including steps performed by the automated system of in-taking from the Seller an indication of the Seller's interest in the Buyer and transmitting to the Buyer a message indicating the Seller's interest in the Buyer without the in-taking from the Seller or the transmitting to the Buyer being conditioned on collecting compensation from the Buyer or Seller, and further including steps performed by the automated system of in-taking from the Buyer a reply to the message indicating the Seller's interest and transmitting the Buyer's reply to the Seller without the in-taking from the Buyer or the transmitting the Buyer's reply being conditioned on collecting compensation from the Buyer or Seller; inventive methods including, before the introducing step (and performed by the automated system): in-taking from the Seller a query associated with the entry for the target item whether the Buyer is still interested, transmitting a confirmatory query to the Buyer for the target item about which the Seller has in-put the query whether the Buyer is still interested, receiving a reply from the Buyer to the confirmatory query, and based on the reply from the Buyer to the confirmatory query, transmitting a message to the Seller indicating whether the Buyer has been confirmed to be still interested; and other inventive methods.

In another preferred embodiment, the invention provides an Internet-based method of introducing a Seller to a plurality of Buyers, comprising: on a website, in-taking from each Buyer of a plurality of Buyers, in computer-readable form, at least a description of a target item along with a price (such as, e.g., a firm non-negotiable price; a negotiable price; etc.) that the Buyer is willing to pay for the target item; from the description of the target item and the price, creating, by operation of a processor, a computer-generated postable entry; conditioning an introduction of the Buyer to the Seller until an event compensating a business entity associated with the website has occurred, such as, e.g., inventive methods including steps performed by the automated system and before the introducing step of via the website, in-taking a search query that was input by the Seller at an input time and returning to the Seller, within seconds of the input time, a list comprising the entries for the respective target items of a quantity of Buyers or links thereto; inventive methods further comprising, for a claimed identity (of a party who is the Buyer or the Seller) in-taken by the website as input from the party, cross-referencing the claimed identity; inventive methods wherein each step is performed by an automated system which further performs a step of computing an Identity Rating for at least one of the Buyer and the Seller; inventive methods including steps of processing a search by the Seller in which a search term used by the Seller is processed by a processor to connect with the target item, in response to the search by the Seller returning a set of search results including a plurality of Buyers having an entry based on the target item, and introducing the Seller to at least one Buyer; inventive methods which include a step of displaying a computed Identity Rating for a party to an opposite party; inventive methods in which introducing of respective buyer-seller pairs is accomplished on a global basis between a pool of buyers that is global and a pool of sellers that is global; inventive methods including a step of displaying a computed Identity Rating for at least one of the Buyer and the Seller to an opposite party who is being introduced or has been introduced to the party for whom the Identity Rating was computed; and other inventive methods.

The invention in another preferred embodiment provides an Internet-based buyer-seller introduction system, comprising: a website including at least one input area configured to receive from a Buyer at least: (1) a description of a target item and a price (such as, e.g., a firm non-negotiable price; a negotiable price; etc.) that the Buyer is willing to pay for the target item; a computer-implemented entry-creator that, from the description of the target item and the price that have been received in the at least one input area, creates a postable entry; a computer-implemented contact information manager that (1) associates a contact information for the Buyer with the entry; and (2) maintains the contact information for the Buyer in confidence until a Compensation-to-the-introduction-service Event has occurred; and a computer-implemented posting manager that posts the entry to the website; such as, e.g., inventive systems wherein the website comprises at least one area configured to receive from a Seller a search query, and the system includes a Seller Search Query processor that processes the Seller's search query input and outputs onto the website a set of search results for viewing by the Seller within seconds of a time when the Seller input the Seller's search query; inventive systems including an automated Cross-Referencer that, for an input which is a claimed identity of a party who is the Buyer or the Seller in-taken by the website as input from the party, cross-references the claimed identity; inventive systems in which for a claimed identity (of a party who is the Buyer or the Seller) in-taken by the website as input from the party, the claimed identity is subjected to cross-referencing; inventive systems including a message generator that generates a message, viewable by a Seller who is using the website, indicating how many previous responses have been sent to the Buyer, before the Seller takes action to incur a charge to be introduced to the Buyer; inventive systems which display a computed Identity Rating for a party to an opposite party; inventive introduction systems which in operation introduce respective buyer-seller pairs on a global basis between a pool of buyers that is global and a pool of sellers that is global; inventive systems that display a computed Identity Rating for at least one of the Buyer and the Seller to an opposite party who is being introduced or has been introduced to the party for whom the Identity Rating was computed; and other inventive systems.

The invention in another preferred embodiment provides an automated seller-side research method, comprising: via a website, in computer-readable form, in-taking a search query for a target item being researched by a Seller, the Seller's search query having been input by the Seller at an input time, and within seconds of the input time, returning to the Seller a search result, wherein the search result includes: an entry generated from a description of a target item that was in-taken by the website from a Buyer along with a price that the Buyer is willing to pay that was in-taken by the website from the Buyer, or a link to said entry; such as, e.g., inventive methods including, via the website, in-taking from the Buyer, in computer-readable form, at least the description of a target item and the price that the Buyer is willing to pay for the target item; inventive methods including a step, performed by a processor, of processing the Seller's search query against a database containing a plurality of entries generated from machine-readable data in-taken via the website when input by a plurality of Buyers, each entry being associated with a respective Buyer and having a respective target item of a Buyer and a price that the Buyer is willing to pay for the target item associated with the entry; and other inventive methods.

In another preferred embodiment, the invention provides for a method of computing an Identity Rating (such as, e.g., computing an Identity Rating based on cross-referencing wherein the cross-referencing is performed on a claimed identity (of a party who is the Buyer or the Seller) in-taken by the website as input from the party; computing an Identity Rating by processing input data from at least two input sources; computing an Identity Rating by at least processing input that is data from at least one social networking website; computing an Identity Rating by at least processing input that is at least one referral reference stored in a database; computing an Identity Rating by at least processing input that is a set of feedback stored in a database; etc.) for at least one of a Buyer and a Seller in an Internet-based introduction system; inventive methods which include a step of displaying a computed Identity Rating for a party to an opposite party; inventive methods including a step of displaying a computed Identity Rating for at least one of the Buyer and the Seller to an opposite party who is being introduced or has been introduced to the party for whom the Identity Rating was computed; and other inventive methods.

The invention in another preferred embodiment provides a method of introducing at least one Buyer to at least one Seller, comprising the steps performed by an automated system of: via a website viewable by the Buyer and the Seller, in-taking from the Buyer, in computer-readable form, at least a description of a target item and a price (such as, e.g., a firm non-negotiable price; a negotiable price; etc.) that the Buyer is willing to pay for the target item; generating an entry for the target item of the Buyer (such as, e.g., an entry that includes a geographical location of the Buyer; etc.), and posting the entry on the website; computing an Identity Rating for at least one of the Buyer and the Seller (such as, e.g., computing an Identity Rating based on cross-referencing wherein the cross-referencing is performed on a claimed identity (of a party who is the Buyer or the Seller) in-taken by the website as input from the party; computing the Identity Rating by, for a predefined first condition, ascertaining that the first condition exists) and maintaining the computed Identity Rating in a database as a displayable Identity Rating (such as, e.g., maintaining in the database a displayable Identity Rating equal to a first value), the displayable Identity Rating being updatable; re-computing the Identity Rating (such as, e.g., re-computing the Identity Rating by, for a predefined second condition, ascertaining that the second condition exists; re-computing the Identity Rating by, for a predefined second condition, ascertaining that the second condition exists followed by repeating re-computing the Identity Rating by, for a predefined third condition, ascertaining that the third condition exists; a re-computing step that includes ascertaining that a condition exists of an individual verifier having verified, in-person, that the Buyer or the Seller who is the subject of the Identity Rating is as claimed; etc.) and updating the displayable Identity Rating in the database to be the re-computed Identity Rating (such as, e.g., maintaining in the database a displayable Identity Rating equal to a second value which is greater than the first value; maintaining in the database a displayable Identity Rating equal to a third value which is greater than the second value which is greater than the first value; maintaining in the database a displayable Identity Rating equal to a highest value of a set of values which the Identity Rating may take; etc.); and introducing the Buyer to the Seller; wherein each step is performed by one or more of: a computer, a computer processor, a computer network, a machine or another non-human instrumentality, or a combination thereof. Inventive methods optionally may further include a step of displaying the displayable Identity Rating for at least one of the Buyer and the Seller to an opposite party who is being introduced or has been introduced to the party for whom the Identity Rating was computed.

The invention in another preferred embodiment provides a method of rating an identity claimed by an on-line user, comprising the steps performed by an automated system of: for the on-line user who has claimed the identity to the automated system, computing an Identity Rating (such as, e.g., computing an Identity Rating based on cross-referencing wherein the cross-referencing is performed on a claimed identity (of a party who is the Buyer or the Seller) in-taken by the website as input from the party) and maintaining the computed Identity Rating in a database as a displayable Identity Rating, the displayable Identity Rating being updatable; re-computing the Identity Rating and updating the displayable Identity Rating in the database to be the re-computed Identity Rating (such as, e.g., a re-computing step, performed by a processor, that includes ascertaining that a condition exists of an individual verifier having verified, in-person, that the identity of the on-line user is as claimed, followed by maintaining in the database a displayable Identity Rating equal to a highest value of a set of values which the Identity Rating may take; etc.); wherein each step is performed by one or more of: a computer, a computer processor, a computer network, a machine or another non-human instrumentality, or a combination thereof; such as, e.g., inventive methods further comprising displaying the displayable Identity Rating for the on-line user to an opposite party; inventive methods that include computing, performed by a processor, the Identity Rating by, for a predefined first condition, ascertaining that the first condition exists, followed by maintaining in the database a displayable Identity Rating equal to a first value; inventive methods that include re-computing, performed by a processor, the Identity Rating by, for a predefined second condition, ascertaining that the second condition exists, followed by maintaining in the database a displayable Identity Rating equal to a second value which is greater than the first value; inventive methods that include repeating, performed by a processor, the re-computing the Identity Rating by, for a predefined third condition, ascertaining that the third condition exists, followed by maintaining in the database a displayable Identity Rating equal to a third value which is greater than the second value; and other inventive methods.

In another preferred embodiment, the invention provides a method of introducing at least one Buyer seeking to obtain an experience to at least one Seller, comprising the steps performed by an automated system of: via a website viewable by the Buyer and the Seller, in-taking from the Buyer, in computer-readable form, at least a description of a target item which is an experience and a price (such as, e.g., a firm non-negotiable price; a negotiable price; etc.) that the Buyer is willing to pay for the experience (such as, e.g., an in-taking step that includes in-taking a description for an experience that would require participation or cooperation of at least one individual or business entity who or which at a time of the in-taking is not publicly offering, within a regular course of the individual or the business entity's business, a service which would correspond to the experience); wherein the step or steps are performed by one or more of: a computer, a computer processor, a computer network, a machine or another non-human instrumentality, or a combination thereof; such as, e.g., inventive methods further comprising generating an entry for the experience which is the target item of the Buyer, and posting the entry on the website, the steps of the method being performed by one or more of: a computer, a computer processor, a computer network, a machine or another non-human instrumentality, or a combination thereof; inventive methods further comprising introducing the Buyer to the Seller, the steps of the method being performed by one or more of: a computer, a computer processor, a computer network, a machine or another non-human instrumentality, or a combination thereof; and other inventive methods.

In another preferred embodiment, the invention provides an Internet-based method for a Seller to pursue selling an item without needing to post an entry for the item, comprising: via a website, in computer-readable form, in-taking a search query for a target item being researched by a Seller, and returning to the Seller a search result, wherein the search result includes: an entry generated from a description of a target item that was in-taken by the website from a Buyer along with a price that the Buyer is willing to pay that was in-taken by the website from the Buyer, or a link to said entry; such as, e.g., inventive methods including a step, performed by a processor, of processing the Seller's search query against a database containing a plurality of entries generated from machine-readable data in-taken via the website when input by a plurality of Buyers, each entry being associated with a respective Buyer and having a respective target item of a Buyer and a price that the Buyer is willing to pay for the target item associated with the entry; inventive methods further comprising an automated step of introducing the Seller to the Buyer, wherein the Seller is introduced to the Buyer without the Seller having had to post an entry for the item; and other inventive methods.

### BRIEF DESCRIPTION OF THE DRAWINGS

FIG. 1 is a diagram of an inventive embodiment depicting automated introducer system 100 that receives input from a buyer B1 and a seller S1, at a time before buyer B1 and seller S1 have been introduced.

FIG. 1A is a diagram corresponding to FIG. 1 at a time after which buyer B1 and seller S1 have been introduced by the automated introducer system 100.

FIG. 2 is an activity diagram which is an Application Navigation Map which may be used in constructing a system 100.

FIG. 3 is a diagram which is a Buyer Landing Page which may be used in constructing a system 100 especially buyer functionality. The Buyer Landing Page has links to main buyer functionality.

FIG. 4 is a diagram which is a further application navigation map which may be used in constructing a system 100 especially seller functionality.

FIGS. 5-8 are examples of screens that may be displayed by a website used in a system 100, including an exemplary homepage (FIG. 5); an exemplary User Account website page (FIG. 6); an exemplary screen that may be displayed to a seller S1 as a Search Results website page (FIG. 7); and an exemplary screen that may be displayed to a seller S1 as a Refined Search Results Detail of Buyers website page (FIG. 8).

FIGS. 9-9C are print screens of another embodiment of an inventive website that may be used in system 100, including an exemplary Home Page (FIG. 9); an exemplary My Account Page (FIG. 9A); an exemplary Search Results Page (FIG. 9B); and an exemplary Refined Search Results Page (FIG. 9C).

FIG. 10 is a flow chart of an inventive buyer-seller introduction method practiced by an automated system 100 in an exemplary embodiment, where the buyer-side can be especially appreciated.

FIG. 10A is a flow chart of an inventive buyer-seller introduction method practiced by an automated system 100 in an exemplary embodiment, where the seller-side can be especially appreciated.

FIGS. 11-15 are diagrams showing exemplary steps which may be practiced to reach FIG. 1A from FIG. 1.

FIG. 16 corresponds to FIG. 1 and is a diagram of an inventive automated system 100 as shown in FIG. 1 including an introductions website in use by users including a plurality of Buyers B1, B2 . . . Bn and a plurality of Sellers S1, S2 . . . Sn.

FIG. 17 is a flow chart of an exemplary inventive Identity Rating method.

FIG. 18 is a diagram of an automated Identity Rating system.

FIG. 19 is a flow chart of an exemplary inventive method that an inventive automated system 100 may perform.

### DETAILED DESCRIPTION OF A PREFERRED EMBODIMENT OF THE INVENTION

A preferred embodiment of the invention is described with reference to the Figures, without the invention being limited thereto.

Most preferably inventive methods are practiced with each step being performed by one or more of: a computer, a computer processor, a computer network, a machine or another non-human instrumentality, or a combination thereof.

Herein, “Buyer” includes a user who may intend to buy whether the user ultimately actually buys. Likewise, herein “Seller” includes a user who may intend to sell whether the user ultimately actually sells. A most preferred example of a Buyer or Seller is a human individual acting for himself or on behalf of an organization or business. A user of an inventive website may be a Buyer on one occasion with regard to one target item that he wants to buy and a Seller on another occasion with regard to another item that he wants to sell. A business or entity may be a Buyer or Seller; for example, a business that needs an automotive part may be a Buyer and a business that has a surplus inventory may be a Seller.

Herein, “target item” includes anything, whether tangible or intangible, that may be bought and sold, such as, e.g., jewelry, vehicles, artwork, furniture, vehicles, machinery, other products, goods, services, real estate, experiences, animals, intellectual property, property rights, etc. Examples of a target item that is an experience is, e.g., a luncheon with a celebrity, space travel, etc.

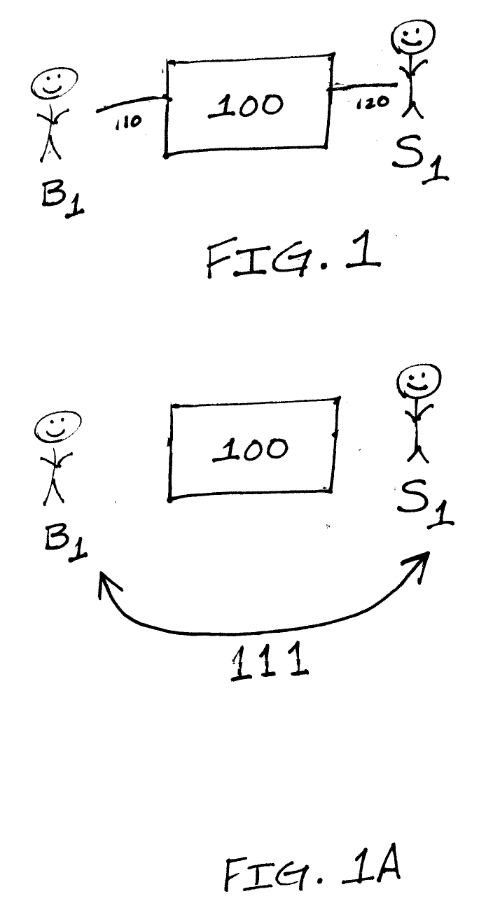

In this invention, advantageously an introduction is made between a buyer (such as buyer B1 in FIG. 1) and a seller (such as S1 in FIG. 1). Referring to FIG. 1, automated introducer system 100 is respectively accessible to a buyer B1 who wants to buy a target item (such as, e.g., a good, a service, an experience, real estate, intellectual property, a business, etc.) and to a seller S1, buyer B1 and seller S1 having not yet been introduced to each other. Automated introducer system 100 is, e.g., a computer-based or processor-based system or network. The system 100 is accessible to the buyer B1 through a buyer's system accessing gateway 110. The system 100 is accessible to the seller S1 through a seller's system accessing gateway 120. The system 100 is constructed using as components, e.g., a combination selected from the group consisting of processors, databases, servers, computer-readable media, machine-readable instructions and website pages.

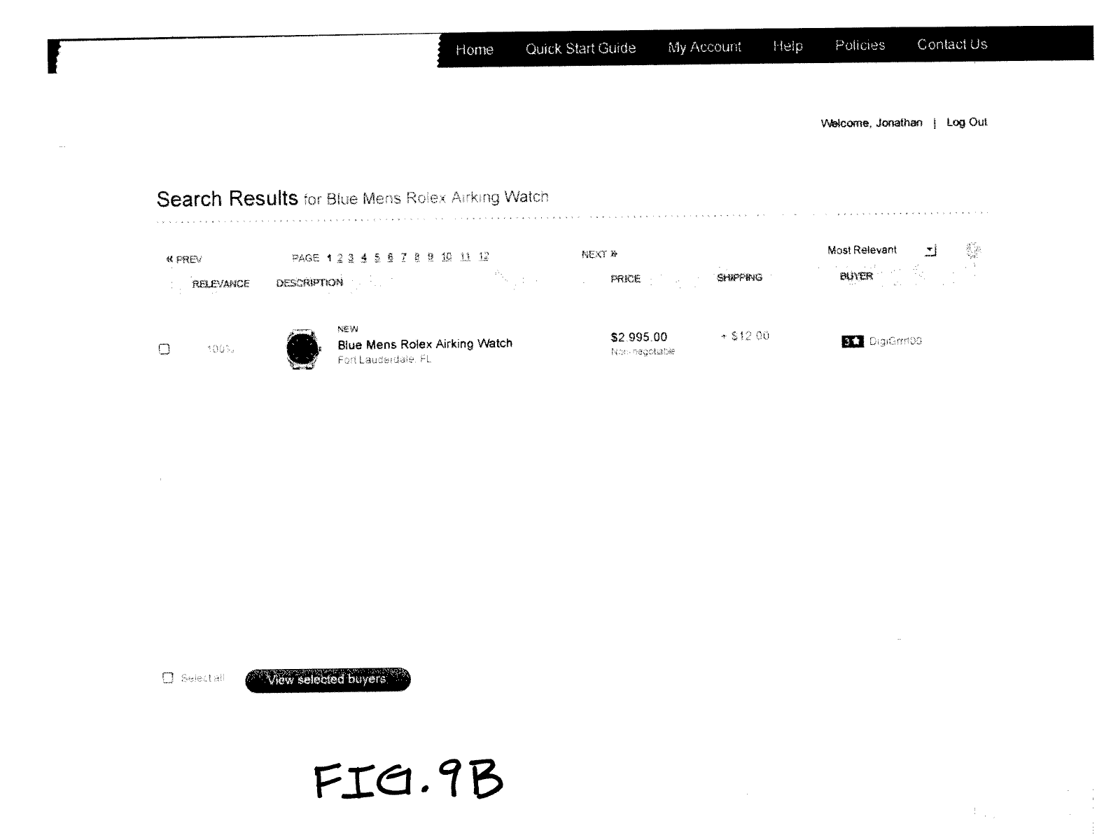

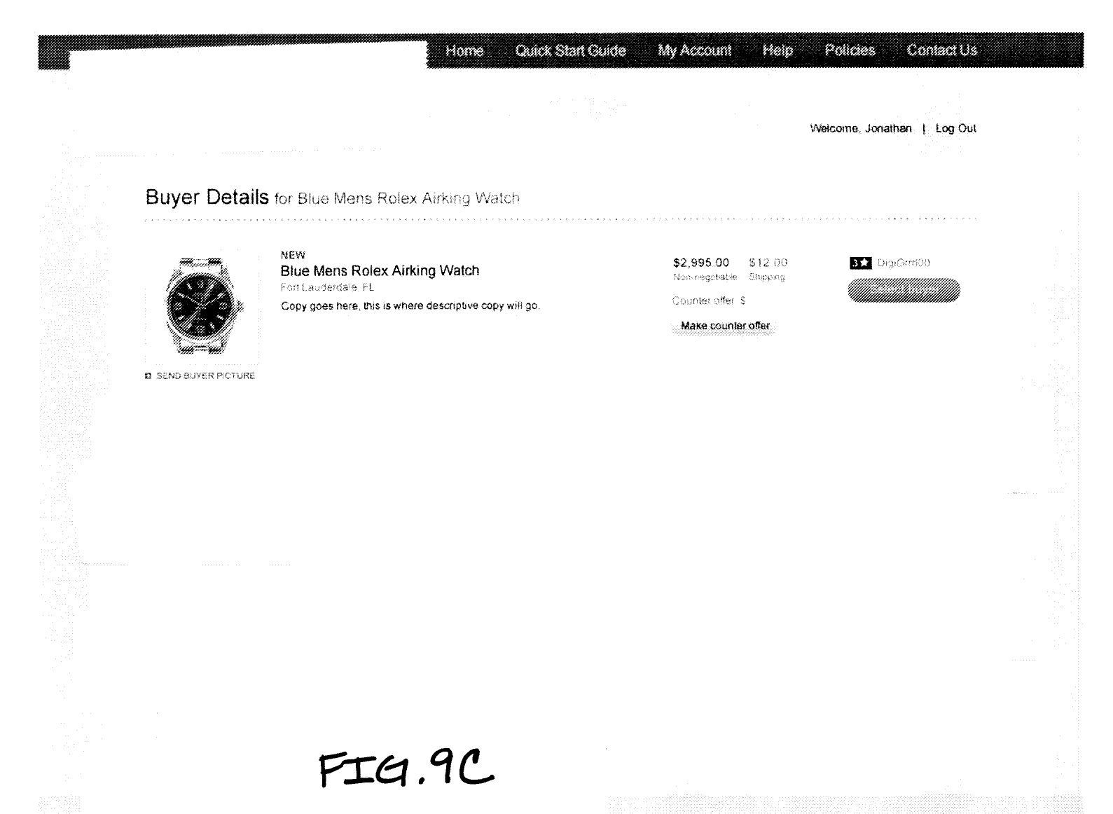

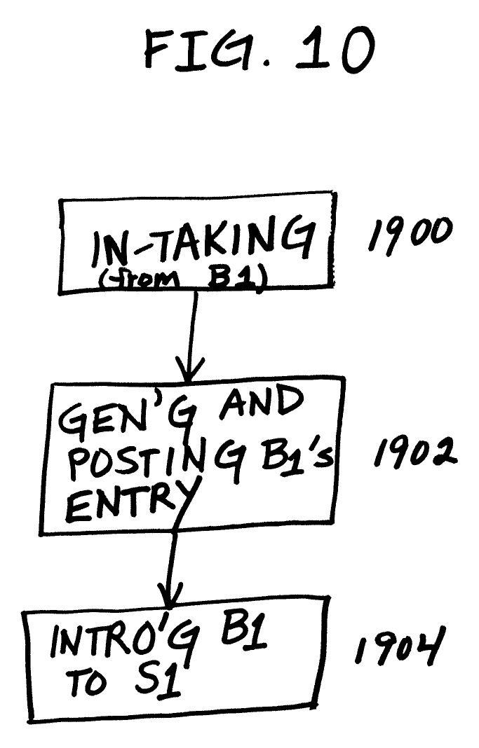

In a preferred example, automated system 100 performs steps comprising in-taking 1900 (FIG. 10) from Buyer B1, followed by generating and posting an entry 1902 (FIG. 10), followed by introducing 1904 (FIG. 10) B1 and Seller S1. Preferably the automated system 100 performs the in-taking step 1900 by, via a website viewable by the Buyer B1 and the Seller S1, in-taking from the Buyer B1, in computer-readable form, at least a description of a target item and a price that the Buyer is willing to pay for the target item, and then performs step 1902 by generating an entry for the target item of the Buyer B1 and posting the entry on the website. Preferably automated system 100, after in-taking 1900 and generating/posting 1904 but before introducing 1904 the buyer B1 and seller S1, performs a step of, via the website, in-taking 1901 (FIG. 10A) a search query that was input by the Seller at an input time, and returning 1903 (FIG. 10A) to the Seller (preferably within seconds of the input time), a list comprising the entry for the target item of the Buyer or a link thereto and, optionally, comprising one or more further entries or further links to entries respectively generated from a plurality of Buyers.

A system 100 preferably includes an Internet website, with the buyer's system-accessing gateway 110 and the seller's system-accessing gateway 120 being respectively operated through the Internet website. An Internet website, once constructed for use in a system 100, preferably operates itself in normal operation through, e.g., processors, servers, databases, and other computer- or machine-based components.

For simplicity, only buyer B1 and seller S1 are shown but the system 100 preferably is accessible by a plurality of other buyers and sellers (not shown), most preferably with a plurality of other buyers and sellers (not shown) having simultaneous access.

System 100 determines, by performing computer-implemented or machine-based steps and without reverting to a human operator, whether seller S1 is, or is not, to be referred to buyer B1. Buyer B1 and seller S1 may provide input into the system 100 at different times through their respective channels 110, 120 and are not required to be on-line at the same time or in any particular order. Information provided by buyer B1 or seller S1 into the system 100 is stored in machine-readable form by the system 100.

The system 100 has as its objective as shown in FIG. 1A that buyer B1 is put in direction communication 111 with a seller S1, with the proviso that buyer B1 and seller S1 be put in such direct communication 111 with each other if and only if information provided by seller S1 via the seller accessing gateway 120 is screened by system 100 and returns a result that seller S1 has represented that seller S1 is selling what buyer B1 wants to buy at the price (such as, e.g., a firm non-negotiable price; a negotiable price; etc.) that buyer B1 wants to pay. Seller S1 is unable to gain direct communication 111 with buyer B1 via system 100 unless seller S1 passes such processor-based screening as may be established based on input that system 100 has received from buyer B1, which input by buyer B1 is processed by system 100 into executable instructions for screening-out sellers.

“Direct communication” 111 herein means and refers to any communication between a buyer B1 and seller S1 not routed by or through system 100. Examples of direct communication 111 are, e.g., emailing each other directly, telephoning each other directly, meeting each other in person, etc.

“Introducing” herein means providing sufficient information to at least one party, of a pair of parties, for the party receiving the sufficient information to establish direct communication with the other party, such as, e.g., introducing by providing to a party the opposite party's contact information (such as, e.g., introducing by providing to a Seller a Buyer's contact information). An example of opposite parties are a Buyer and a Seller. A preferred example of introducing is by providing at least one party of two opposite parties an email address of the opposite party, such as by providing to the Seller the Buyer's email address (most preferably, after the Buyer has specifically and in real-time approved that the Buyer's email address is to be provided to the Seller).

Preferably, system 100 is constructed so that buyer B1's time invested using gateway 110 (FIG. 1) to arrive at the desired outcome of direct communication 111 (FIG. 1A) is minimal or greatly minimized compared to other methods of buyer B1's ultimately connecting directly to seller S1 or another person selling the particular item that buyer B1 wants to buy (such as, e.g., searching beginning with Google-based searching; searching on Ebay followed by bidding on one or more offered examples of the item that buyer B1 wants to buy; searching on Ebay and locating a “buy now” example of the item that buyer B1 wants to buy; etc.).

In a case where a buyer B1 wants to buy a particular item, system 100 receives information from buyer B1 about that particular specific item, which received information system 100 processes through one or more computer-implemented steps into an entry which is devoid of buyer B1's contact information, said entry being posted on a website that is part of system 100 and accessible to sellers including seller S1.

Preferably, an entry posted on a website includes a geographical location of the Buyer.

Preferably, a website used in system 100 receives input entered using any alphabet or characters for which computers are configured such as Roman, Greek, Cyrilic, Chinese, Japanese, Korean, etc. By using such a website in system 100, advantageously language is put to work as a sorting factor and buyer-seller pairs who are working in the same language as each other are introduced.

System 100 is configured to receive through gateway 120 an indication from seller S1 of seller S1's interest in being introduced to the buyer B1 in order for seller S1 to communicate directly with buyer B1 about negotiating a transaction for the subject item of the posted entry. System 100 performs computer-based processing of any indication from seller S1 that seller S1 wants to sell the subject item of the posted entry before system 100 releases such information as would permit direct communication 111 to be established between buyer B1 and seller S1. For example, system 100 may screen the information provided by seller S1 through gateway 120 for whether seller S1 would violate any restrictions specified by buyer B1 such as, e.g., geographic restrictions, storefront restrictions, reference restrictions, user credibility scoring restrictions, etc. For example, a buyer B1 may have specified unwillingness to deal with a seller S1 outside a certain geographic area or may have specified willingness to deal with a seller S1 only if seller S1 was within a certain geographic area. By way of another example, a buyer B1 may have specified willingness to deal with a seller S1 only if seller S1 maintains a storefront location. By way of further example, a buyer B1 may have specified that the buyer B1 is only to be connected directly to a seller S1 if and only if the system 100 can determine that certain reference restrictions and/or user credibility scoring restrictions are met.

System 100 preferably is used in a method of introducing a buyer B1 to a seller S1, without using any human other than the buyer B1 and the seller S1 to perform any of the following steps, the method comprising the steps of: in-taking by system 100 from the buyer B1 via gateway 110 at least a description of a target item and a price (such as, e.g., a firm non-negotiable price; a negotiable price; etc.) that the Buyer is willing to pay for the target item, in computer-readable form; generating by the system 100 an entry for the target item; posting by the system 100 the entry on a website which is part of the system 100; introducing by the system 100 the buyer B1 to the seller S1; wherein the in-taking, generating, posting and introducing steps are performed by system 100 such as steps performed by one or more of: a computer, a computer processor, a computer network, a machine or another non-human instrumentality, or a combination thereof.

Optionally but preferably automated introduction system 100 performs, e.g., a step of gathering information about seller S1 that will be of interest to the buyer B1, a step of evaluating seller S1, etc. For example, preferably system 100 gathers information about seller S1 in addition to information that seller S1 himself provides through gateway 120. Examples of system 100 gathering information about seller S1 are, e.g., system 100 gathering information about seller S1 from a social website such as Facebook, etc.; system 100 gathering information about seller S1 from a credit-rater such as, e.g., Dun and Bradstreet, a credit agency, etc.; system 100 gathering information about seller S1 from a litigation database such as, e.g., Lexis; system 100 gathering information about seller S1 from a governmental database such as, e.g., a database of court records; etc.

Preferably the invention is practiced in an embodiment in which a buyer-seller introduction is monetized, with examples of a monetization system being, e.g., an introduction-based fee; a commission; etc. System 100 preferably includes a monetization subsystem by which a monetary charge is collected for accomplishing introduction of a buyer B1 and seller S1 into direct communication 111. For example, a seller S1 may be advised by the system 100 that if the seller selects (such as, e.g., by clicking on a selected buyer followed by hitting a submit button for) a buyer, then an automated message will be sent to the selected buyer in order to confirm that the selected buyer is interested in providing the seller with the buyer's contact information, and if the buyer agrees to provide the buyer's contact information, the seller will be charged a fee. As another example, a seller S1 may be advised by the system 100 that if the seller selects (such as, e.g., by clicking on a selected buyer followed by hitting a submit button for) one or more buyers, then an automated message will be sent to each selected buyer in order to confirm that each selected buyer is interested in providing the seller with the buyer's contact information, and for each buyer that agrees to provide the buyer's contact information, the seller will be charged (such as, e.g., charged a flat fee (such as, e.g., $1); charged a percentage of a purchase; etc.). Preferably the monetization subsystem used in a system 100 is based on charging a seller S1 for being introduced to a buyer B1 who has expressed willingness to be in direct communication 111 with the seller S1. FIG. 8 shows an example of a screen in which a seller S1 is advised that a $1.00 USD charge will be incurred by the seller S1 for a buyer B1 that the seller has selected if the seller S1 hits a submit button and if the buyer B1 then accepts the introduction being made.

While a monetization subsystem (such as, e.g., a monetization subsystem in which a processor imposes a charge based on the buyer B1's accepting an introduction to seller S1 into direct communication 111 between buyer B1 and seller S1) is a preferred component of a system 100, system 100 does not require a monetization subsystem in all embodiments.

When a monetization subsystem is used in a system 100, optionally the monetization subsystem may, e.g., waive a fee for a first customer transaction, use a tiered fee structure, etc. One example of a monetization subsystem using a tiered fee structure is a monetization subsystem in which a processor using a table of at least two fee amounts returns a fee amount to charge the seller. For example, an introduction to a buyer who has completed at least one purchase as recorded by the system 100 may be assigned a higher fee amount than a new buyer without any completed purchase on record yet in the system 100.

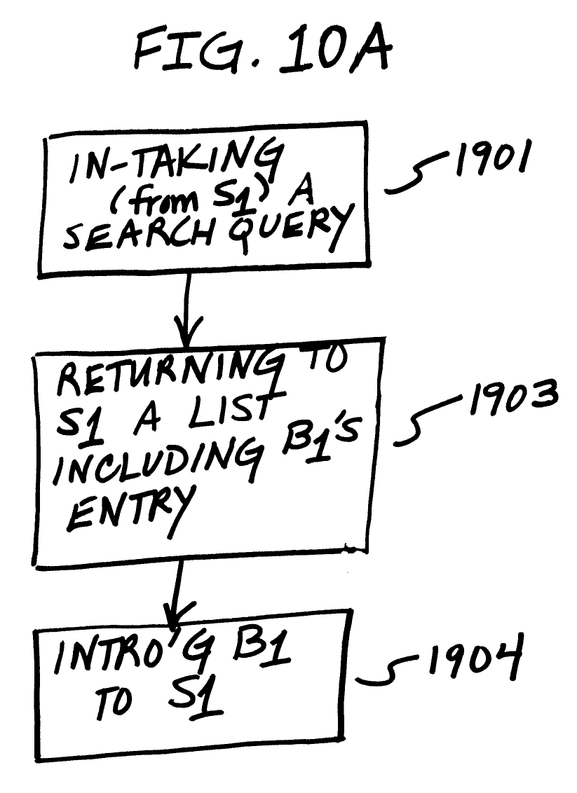

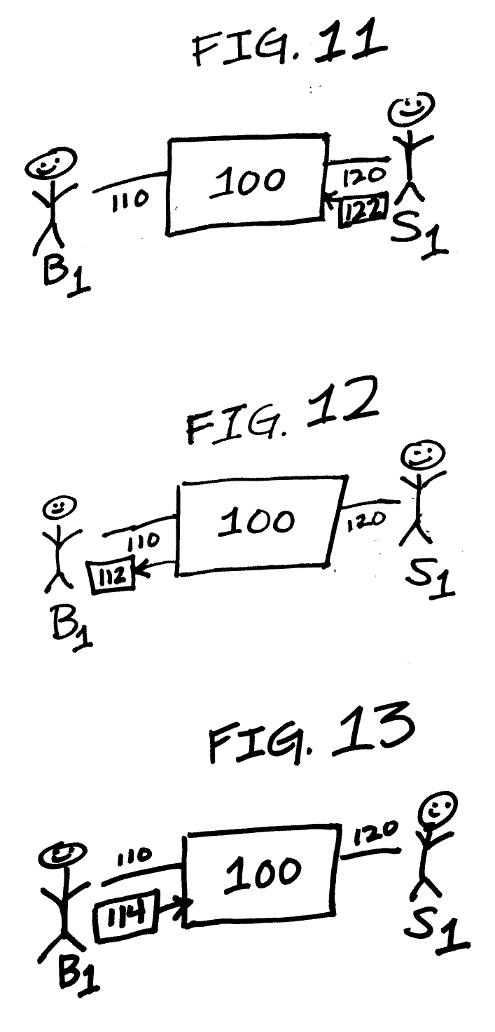

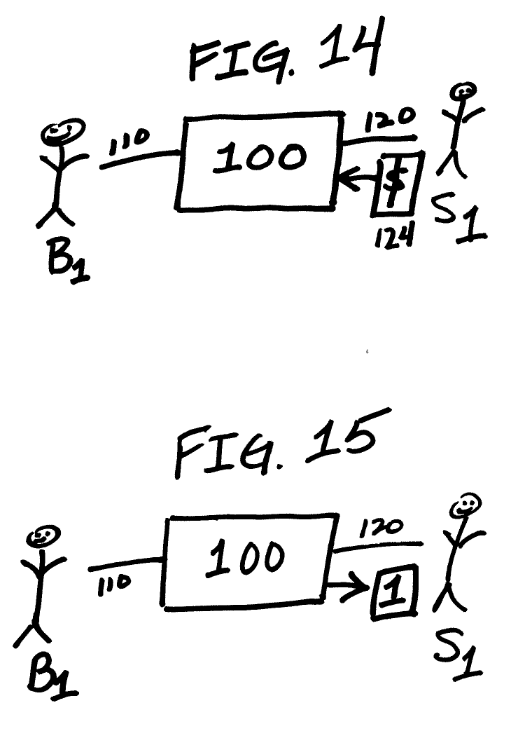

For reaching direct communication 111 (FIG. 1A) between Buyer B1 and Seller S1 (FIG. 1), a preferred examples is to practice the steps of FIGS. 11 -15. Upon a Seller S i's viewing a website which is part of system 100, on which website is posted an entry assembled by the system 100 from a description in-taken by the system 100 from the Buyer B1's description of the target item that Buyer B1 wants to buy and the price that the Buyer B1 is willing to pay for the target item, the Seller S1 sees an entry of interest and sends an indication 122 (FIG. 11) to the system 100 that the Seller S1 wants to be introduced to the buyer associated with the Seller-viewed entry, which the system 100 recognizes is Buyer B1. The system 100 then sends a communication 112 (FIG. 12) to the Buyer B1 in which communication 112 the system 100 advises the Buyer B1 of the existence of seller-side interest in being introduced to Buyer B1. Buyer B1, upon receiving communication 112 from the system 100 advising of the existence of the seller-side interest, may respond to the system 100 by sending an authorization 114 (FIG. 13) for the system 100 to release Buyer B1's contact information in response to the Seller's indication 122. System 100, having received Buyer B1's authorization 114, receives payment 124 (FIG. 14) from or on behalf of Seller S1. System 100, after having received payment 124 (FIG. 14), sends, to Seller S1, Buyer B1's contact information 1 (FIG. 15) which system 100 had previously received from Buyer B1. Optionally, system 100 after having been paid also may send (not shown) Seller Si's contact information to Buyer B1. Alternatively, after having been paid, system 100 instead of releasing the Buyer B1's contact information to Seller S1 as shown in FIG. 15, system 100 may release Seller S1's contact information to Buyer B1.

Optionally but preferably, system 100 computes a scoring algorithm computed by a processor or other machine on input data which are processed to compute a User Rating for a user who is a buyer or a seller, from which the system 100 outputs a User Rating. Preferably the computing of the scoring algorithm by system 100 includes processing, performed by a processor, of input data from at least two data input sources. Examples of data input for processing by the processor computing the scoring algorithm, are, e.g., input data which is from a social networking website external to system 100, input data which is at least one referral reference received into system 100 by a non-user; input data which is feedback received into system 100 by a user; input data which is from a credibility source external to system 100; etc. Preferably the scoring algorithm is computed in advance of an introduction in which the buyer B1 and seller S1 are put in direct communication 111. For example, a system 100 may be configured to receive as input (such as by receiving into a database) data from a social network site 1001 and/or data that is a referral reference 1002.

In practicing the invention, preferably an Identity Rating process is performed by an inventive automated system with regard to each Buyer and Seller and the Identity Rating for a rated Buyer or Seller is made available to a respective opposite party dealing with the rated party. To obtain data usable for performing Identity Rating, the inventive automated system may perform cross-referencing techniques, such as against information that is available on-line (such as, e.g., a government-maintained database (such as, e.g., a land records database; a business entities database; a database of patent records; etc.) to create a score that reflects how “real” is a rated party's self-described identification. Through the inventive Identity Rating process, an Identity Score is calculated.

An example of an Identity Score system is one in which the more that can be confirmed by the inventive system about the identity of the party being scored, the higher his Identity Score.

The Identity Score may be reported by the inventive automated system as a stand-alone Identity Score and meanwhile a separate User Rating may be reported, or, a combined rating may be reported by the inventive automated system in which the Identity Score and the User Rating are not separately broken-out, or a combination thereof.

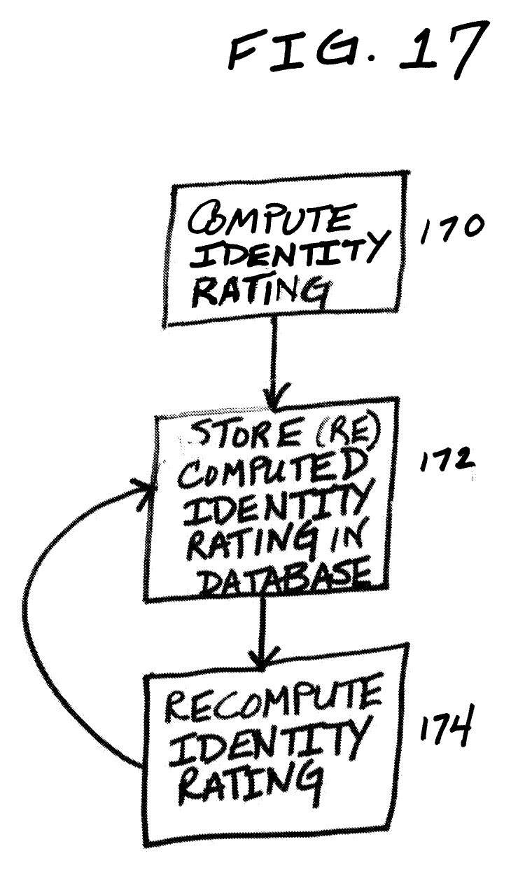

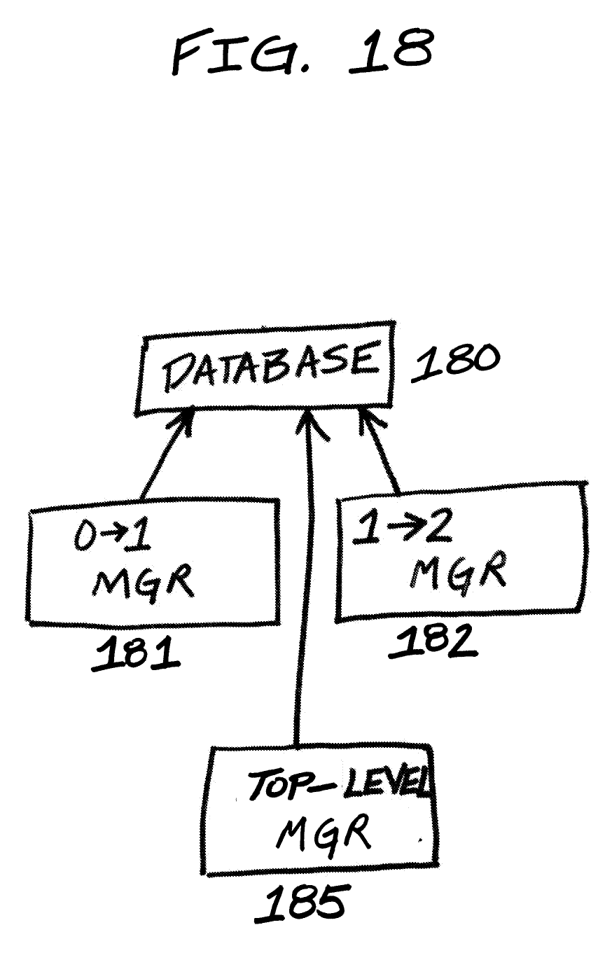

One example of Identity Rating may be appreciated with reference to FIG. 17, in which a processor (such as, e.g., a processor within a system 100), computes 170, followed by storing 172 the Identity Rating which was computed in step 170 in a database (such as database 180 in FIG. 18) as the displayable Identity Rating, followed by re-computing 174 the Identity Rating and storing 172 the re-computed Identity Rating that was re-computed in step 174 in the database as the displayable Identity Rating (replacing the previous displayable Identity Rating).

Preferably, the re-computing step 174 is repeated. In a preferred example, the computing step 170 is performed based on a first condition having been determined to be met wherein the first condition is evaluated based on information provided (such as uploaded, entered as a link, etc.) by the very user for whom an Identity Rating is being calculated, and one or more subsequent re-computing steps 174 are performed based on a condition having been determined to be met wherein the condition is evaluated based on information from a source other than the user for whom an Identity Rating is being calculated. In a preferred example, an Identity Rating for a user is set by a processor (such as a processor within a system 100) at zero. When the user submits information for the processor to process, the processor processes the user-submitted information and computes 170 an Identity Rating based on whether the processor can confirm the first condition having been met, namely, a computed Identity Rating of zero if the processor cannot confirm the first condition having been met and an Identity Rating of one if the processor (such as processor 181 in FIG. 18) can confirm the first condition having been met. An example of a first condition having been met is that the user's name as input for opening an account (such as an account with a website that is part of system 100) matches an individual's name found by the processor processing information uploaded by the user.

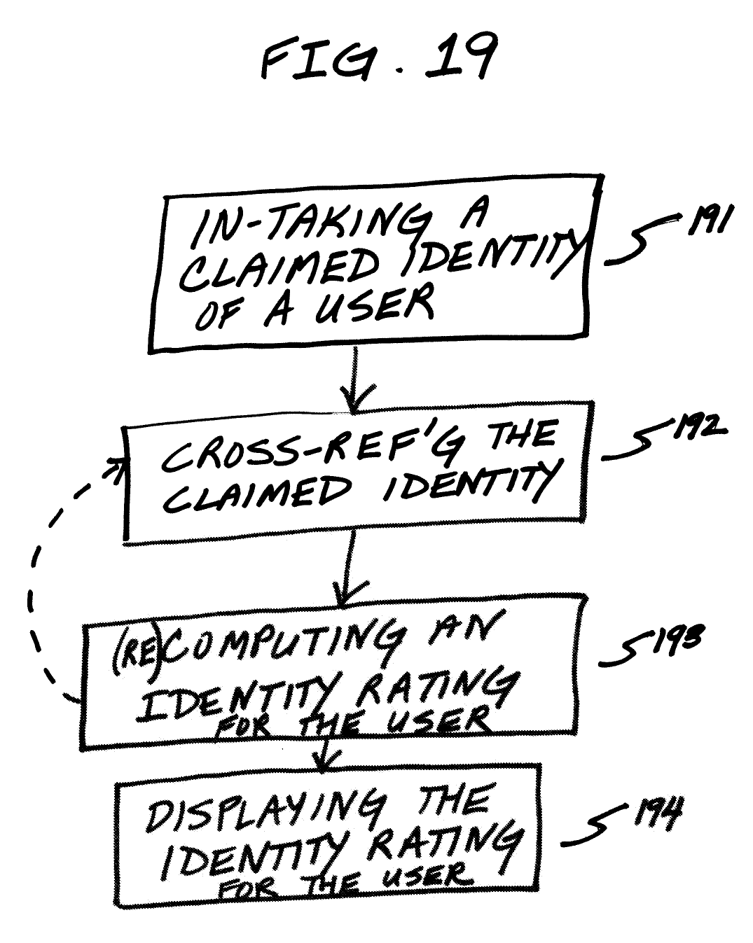

The invention also may be appreciated with reference to FIG. 19, which are steps that an automated system such as system 100 may perform, including in-taking 191 a claimed identity of a user (such as, e.g., a Buyer, a Seller), followed by cross-referencing 192 the claimed identity of the user, followed by computing 193 an Identity Rating for the user (after which computing 193 optionally the cross-referencing 192 may be repeated, preferably as a more demanding cross-referencing step than previously performed, followed by re-computing 193 an Identity Rating for the user), followed by displaying 194 the identity rating for the user to an opposite party who is considering whether to be introduced to the user. A preferred example of an in-taking step 191 is to receive, in computer-readable form, via the website which is part of system 100 a claimed identity of a user which comprises the user's first, middle and last name and current residential address. For a new user, the system 100 creates a record for the user, such as a record based on the email address from which the user is communicating. The system 100 associates the user's claimed identity with the record for the user. The record of the user's claimed identity is stored in the system 100 so as to be accessible for use in methods of Identity Rating in which the record of the user's claimed identity is subjected, e.g., to cross-referencing. Examples of step 193 (FIG. 19) include, e.g., computing 170 (FIG. 17); re-computing 174 (FIG. 17); etc.

An exemplary automated Identity Rating system comprising a database 180 and processor-driven managers 181, 182, 185 is shown in FIG. 18. In a preferred example, the database 180 is indexed by user, with a user being someone who has opened an account with a website (such as a website within system 100) that is associated with the database. When a user opens an account, the user is stored in the database 180 with an Identity Rating of zero associated with him. The 0-to-1 manager 181, which is processor-driven, processes the user records in the database 180 that have a zero Identity Rating associated therewith and/or processes data submitted by a user having a zero Identity Rating. The 1-to-2 manager 182, which is processor-driven, processes the user records in the database 180 that have a one Identity Rating associated therewith. Unlike the 0-to-1 manager, the 1-to-2 manager is not dependent upon information submitted by the user being subjected to an Identity Rating.

It should be appreciated that an Identity Rating system including a top-level manager 185 may have a highest level of Identity Rating greater than three, or equal to three. In another embodiment, the 1-to-2 manager 182 could be the same as the top-level manager 185.

The top-level manager 185, which is processor driven, processes the user records in the database 180 that have an Identity Rating associated therewith that is one less than the highest level. For example, if the highest level of an Identity Rating in an exemplary system is five, the top-level manager 185 processes the user records in the database 180 that have associated therewith an Identity Rating of four. A top-level manager 185 may, for example, sweep the database 180 on a preestablished timetable, locate any user records with a new instance of an Identity Rating of four, process each user record with a new instance of an Identity Rating of four such as a geographic-based processing, followed by requesting an individual who is a verifier in the pertinent geographic area to undertake an in-person verification of the user's identity, followed by the top-level manager 185's receiving, in machine-readable form, the results of the in-person verification.

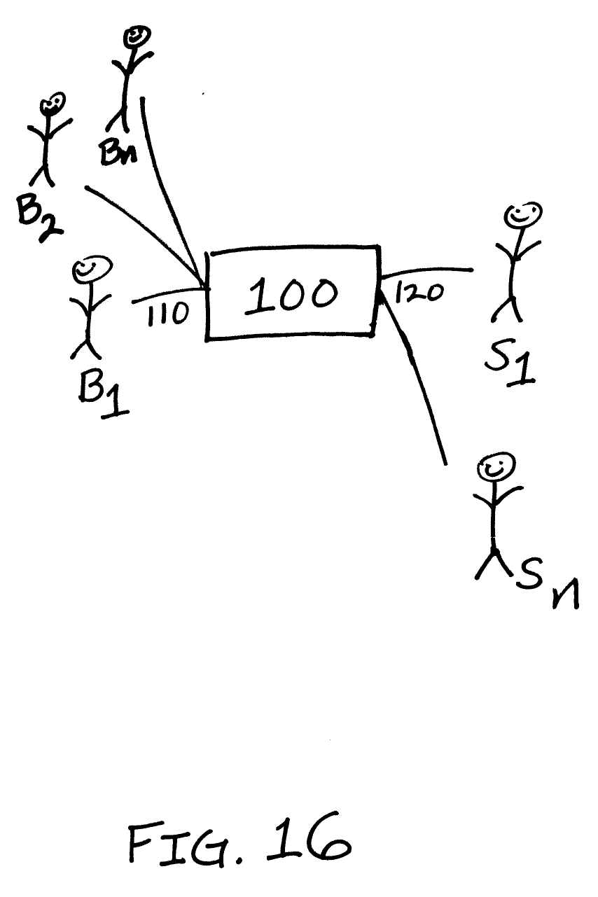

Advantageously the inventive Identity Rating system reduces the chances of a user (such as a Buyer B1 . . . Bn or a Seller S1 . . . Sn in FIG. 16) of an inventive introductions website dealing with a scammer.

Preferably, an inventive automated system 100 is used by a plurality of Buyers B1 . . . Bn and a plurality of Sellers S1 . . . Sn as represented in FIG. 16. The number of Buyers Bn is unlikely to be equal to the number of Sellers Sn. FIG. 16 is a diagram of an inventive automated system 100 including an introductions website in use by users including a plurality of Buyers B1, B2 . . . Bn and a plurality of Sellers S1 . . . Sn. The number of Sellers Sn may be less than, equal to, or greater than the number of Buyers Bn.

In practicing an inventive buyer-seller introductions method, preferably Identity Rating is used, most preferably, Identity Rating based on a point scoring system that uses online cross-referencing to determine how verifiable an individual user (i.e., a buyer or seller) is.

An important use of the invention is for sellers (such as Sellers S1 . . . Sn in FIG. 16) to instantly find buyers (such as Buyers B1 . . . Bn in FIG. 16), and moreover to access big pool of buyers (such as Buyers B1 . . . Bn in FIG. 16). A preferred example of a big pool of buyers is a globalized pool of buyers B1 . . . Bn. By use of a website in system 100, a globalized pool of Buyers B1 . . . Bn may be constructed. Buyers B1 . . . Bn preferably represent users who want to buy a variety of target items with each target item being defined by a respective buyer of the Buyers B1 . . . Bn.

The invention also provides important advantages from buyers' perspectives, especially for buyers who are deal-seekers, buyers seeking a transaction at their comfort price, and patient buyers.

Advantageously for sellers, the invention permits comparative seller-side anonymity, in that the seller is not posting his information for the world to see, but rather is only providing his details to one particular buyer. The invention is particularly useful in providing a website (such as a website which is component of system 100 in FIG. 16) where sellers can go to find buyers.

Methods and systems according to the invention advantageously may be used so that buyers (such as Buyers B1 . . . Bn in FIG. 16) can buy what they want to buy faster than through other channels, and moreover at the price that they want to pay. Meanwhile, and also advantageously, sellers on the selling end of these same transactions may be achieving time-saving advantages on their end.

Advantageously the invention may be used in a website-based embodiment in which a seller visits the website to find a universe of buyers, and a buyer uses the website to be introduced to a seller without the buyer needing to invest much time.

Websites used in practicing the invention may be constructed according to a variety of configurations. The invention may be practiced, e.g., using a website which intakes a Buyer's description for a particular kind of target item or a website which intakes a Buyer's description for two or more kinds of target items. A website through which are in-taken two or more kinds of target items may in-take the different kinds of target items through the same data-entry in-take field or through different data-entry in-take fields.

Advantageously, through using inventive web sites, methods, and systems, a buyer has an ability to list a target item which is an intended purchase (such as, e.g., a product, a service, an experience, an animal, intellectual property, real estate, a business, etc.) and wait for a seller to contact him.

Also advantageously, through using inventive web sites, methods, and systems, buyer-established pricing is provided.

Optionally, inventive web sites, methods, and systems may be configured and constructed to give a user who is a buyer an ability to set a price that is firm without negotiation. Alternatively, inventive web sites, methods, and systems may be configured and constructed to give a user who is a buyer a flexible price option with a counter offer aspect.

Inventive web sites, methods, and systems also may be used to provide the ability for a buyer (or seller) to decide if he wants to transact with each other for the product/service/experience in question, based on price, picture of the item (if applicable), location, shipping rates (if applicable), User Rating, and Identity Rating.

In a particularly preferred embodiment, the invention provides a free listing for buyers, while also providing free searching for sellers, and further while also providing free matching of both buyers and sellers, and only after buyer-seller matches have been made do fees come into the picture when a seller selects a buyer and the buyer confirms wanting to work with the seller.

Preferably the invention is practiced as an introduction service method in which the only charge is to release contact information of the buyer and the seller in a respective buyer-seller pairing. Also preferably, the invention is practiced using a website with a confirmation aspect, wherein a seller selects a buyer and then a message gets sent to the buyer to make sure that the buyer is still interested and only when the buyer confirms does the seller get charged. Preferably the invention is practiced using a flat fee basis for collecting compensation (such as, preferably, a flat fee collected from the seller), but optionally a non-flat fee basis (such as a percentage basis collected from the seller) is used for collecting compensation, and also optionally no compensation need be collected from buyers or sellers (whilst compensation optionally may, or may not, be collected from advertisers).

Inventive methods and systems advantageously and preferably, in operation may be used to give a seller a relatively high degree of certainty of a buyer being an actual customer before the seller is charged for the introduction.

Where a step is performed of in-taking from the Buyer, preferably the step is performed without charge to the Buyer. Where a step is performed of generating and posting an entry for the Buyer's target item on a website, preferably the step is performed without charge to the Buyer. Where a step of introducing the Buyer to the Seller is performed, preferably the step is performed without charge to the Buyer.

In practicing the invention, it is preferred that after an inventive system 100 performs a step of introducing a Buyer and Seller, the Seller is left to directly communicate with the Buyer (such as by the Seller sending the Buyer an email) without the Seller's sending of an email to (or otherwise directly communicating to) the Buyer involving a charge or attempted charge to the Buyer.

The invention may be appreciated with regard to the following examples, without being limited to those examples.

### EXAMPLE 1

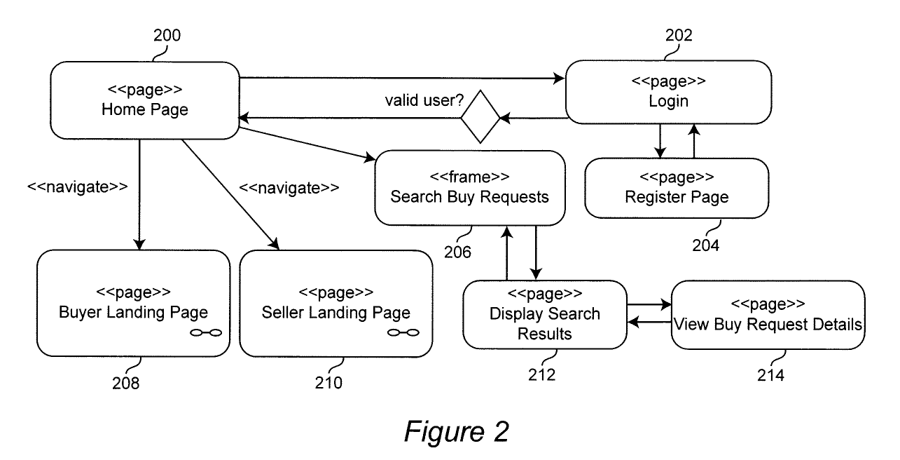

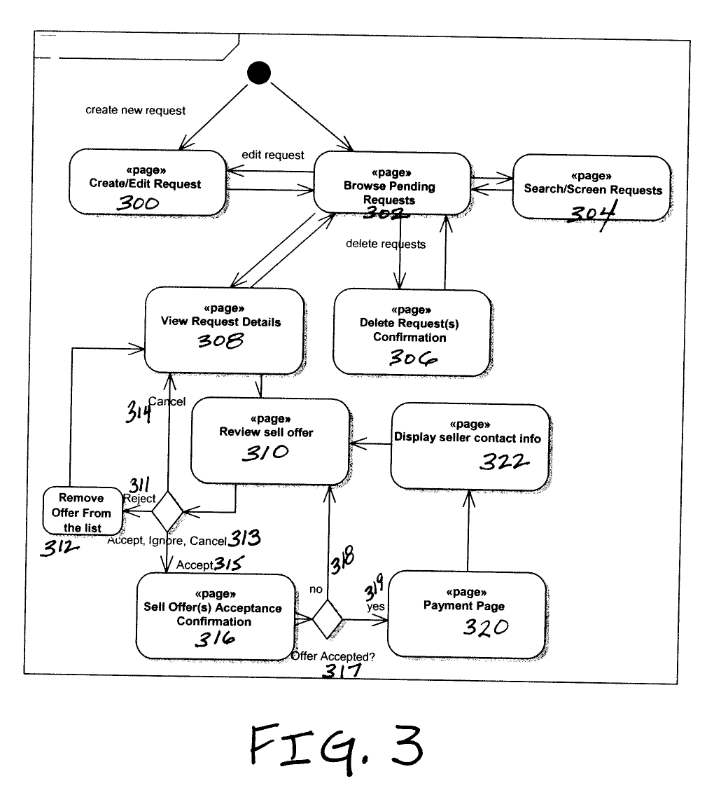

A system 100 in this inventive example includes a home page (such as a Home Page 200 in FIG. 2) which is an Internet web page.

In this Example in which FIGS. 2-8 are mentioned, simpler and more focused reports are possible by, e.g., using the templates of FIGS. 2-8 and turning off sections.

For constructing a system 100, FIG. 2 shows an example of an activity diagram which is an application navigation map which may be used for constructing a system 100. For example, from home page 200 a user can navigate to Login link or page 202 and Register 204 pages and perform a Search of Buy Requests 206. The Login link or page 202 is a user authentication page. The Register Page 204 is constructed to receive registration of a new user, to establish a user name, password, and email. In the application navigation map of FIG. 2, there are also links to landing pages with buyer and seller functionality, namely Buyer Landing Page 208 and Seller Landing Page 210. The Seller Landing Page 210 has links to main seller functionality. A user can navigate to a Display Search Results page 212 and to a View Buy Request Details page 214. On the View Buy Request Details page 214, details (e.g., full description, etc.) of a single buy request are viewable. On a Display Search Results page 212, search results can be browsed by a user.

Referring to FIG. 3, system 100 is constructed so that a user who is a buyer (such as buyer B1) is provided with a Create/Edit Request link 300. The Create/Edit Request link 300 links to an Edit Request, such as an Edit Request categorized by title, description and category (such as electronics→video cameras; jewelry→watches; etc.).

A Browse Pending Requests link 302 is provided, from which a user may navigate to a Search/Screen Requests page 304 or to a Delete Request(s) Confirmation page 306 or to a View Request Details page 308. The View Request Details page 308 displays request details in read-only mode and shows the list of pending sell offers for this request. On the Search/Screen Requests page 304, the user may screen buy requests by keyword or by date. A Delete Request(s) Confirmation page 306 may, e.g., display the list of requests the user checked for deletion and yes/no buttons. The Browse Pending Requests link 302 links to a display of a table view of pending buy requests with the following columns: Request Date; Category; Description, Number of Sell Offers; Icon Indication New (not yet reviewed) Offer has arrived.

From the View Request Details page 308, the user who is a buyer may navigate to a Review Sell Offer page 310. A Review Sell Offer page displays the details of the selected sell offer, such as description, price, seller rating (how many successful transactions occurred in the past) and Accept/Reject/Cancel buttons in which a Reject button is constructed so that a user's selecting the Reject button removes the offer from the pending offers list; an Accept button is constructed so that a user's selecting the Accept button transfers him to the confirmation/charge page; and a Cancel button is constructed so that a user's selecting the Cancel button results in no action being performed other than returning the user to the request details page. For a sell offer that a user reviews, the user proceeds at the Accept, Ignore, Cancel 313 juncture, by a “Reject” 311 route (in which a Remove Offer From the List 312 operation is executed and the user is returned to the View Request Details page 308) or alternatively via a Cancel 314 route (which takes the user back to the View Request Details 308 page) or alternatively via an Accept 315 route (which takes the user to the Sell Offer(s) Acceptance Confirmation page 316).

The Sell Offer(s) Acceptance Confirmation page 316 displays the list of accepted offers and receives from the buyer input that confirms the buyer's intention to proceed. At the Sell Offer(s) Acceptance Confirmation page 316, the user is presented with an Offer Accepted? 317 selection to which if the user selects a No 318 route the user is returned to the Review Sell Offer page 310 and if the user selects a Yes 319 route the user proceeds to the Payment Page 320. A Payment Page is, e.g., a checkout page that allows the seller to enter credit card information or use credit card information stored in a user profile. After successful completion of the Payment Page 320, the user navigates to a Display Seller Contact Information 322 page. A Display Seller Contact Information 322 page displays a seller's contact information.

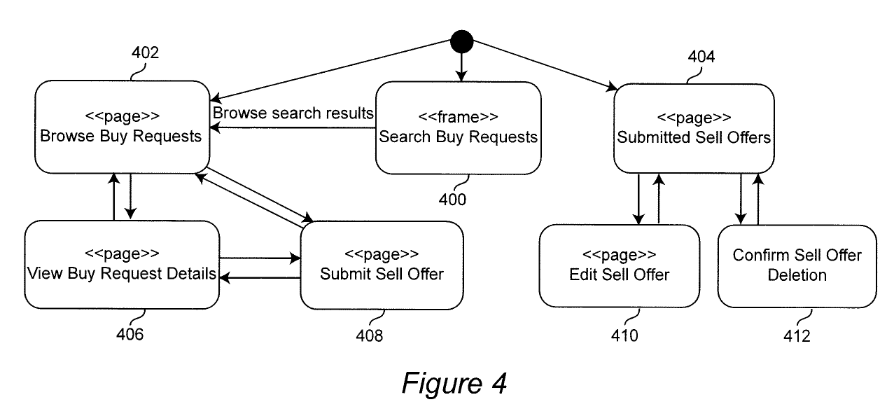

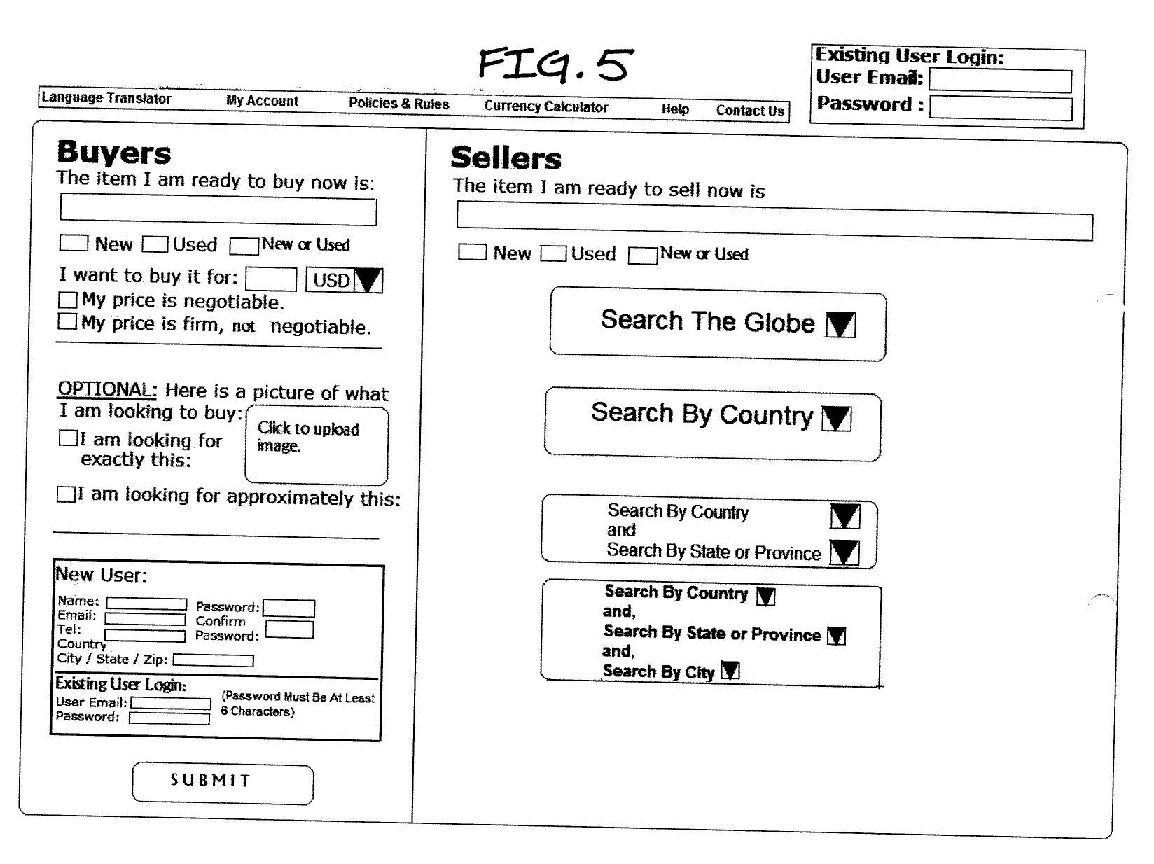

Referring to FIG. 4, system 100 is constructed so that a user who is a seller accesses a Search Buy Requests page 400 or a Browse Buy Requests page 402 or a Submitted Sell Offers page 404. The Search Buy Requests page 400 is part of the home page for receiving search criteria entered by the user who is a seller. The Search Buy Requests page 400 receives as input search criteria entered by a seller, such as search criteria by keywords, category and/or buy request date range. On the Browse Buy Requests page 402, a user who is a seller browses buy requests, either all or from search results. The Browse Buy Requests page 402 allows the seller to select one or more buy requests and submit a sell offer. From the Browse Buy Requests page 402, the user navigates to a View Buy Requests page 406 or a Submit Sell Offer page 408. On the Submit Sell Offer page 408, the user who is a seller may enter an item description and price and submit a sell offer.

On the Submitted Sell Offers page 404, the user is able to browse the list of pending sell offers and buyer responses, and is to edit or delete a sell offer. From the Submitted Sell Offer page 404, the user navigates to an Edit Sell Offer page 410 or a Confirm Sell Offer Deletion page 412. On the Edit Sell Offer page 410, the user who is a seller can edit an existing sell offer (such as to change description, price, or another attribute of a sell offer). On the Confirm Sell Offer Deletion page 412, the user can confirm deletion of a sell offer(s).

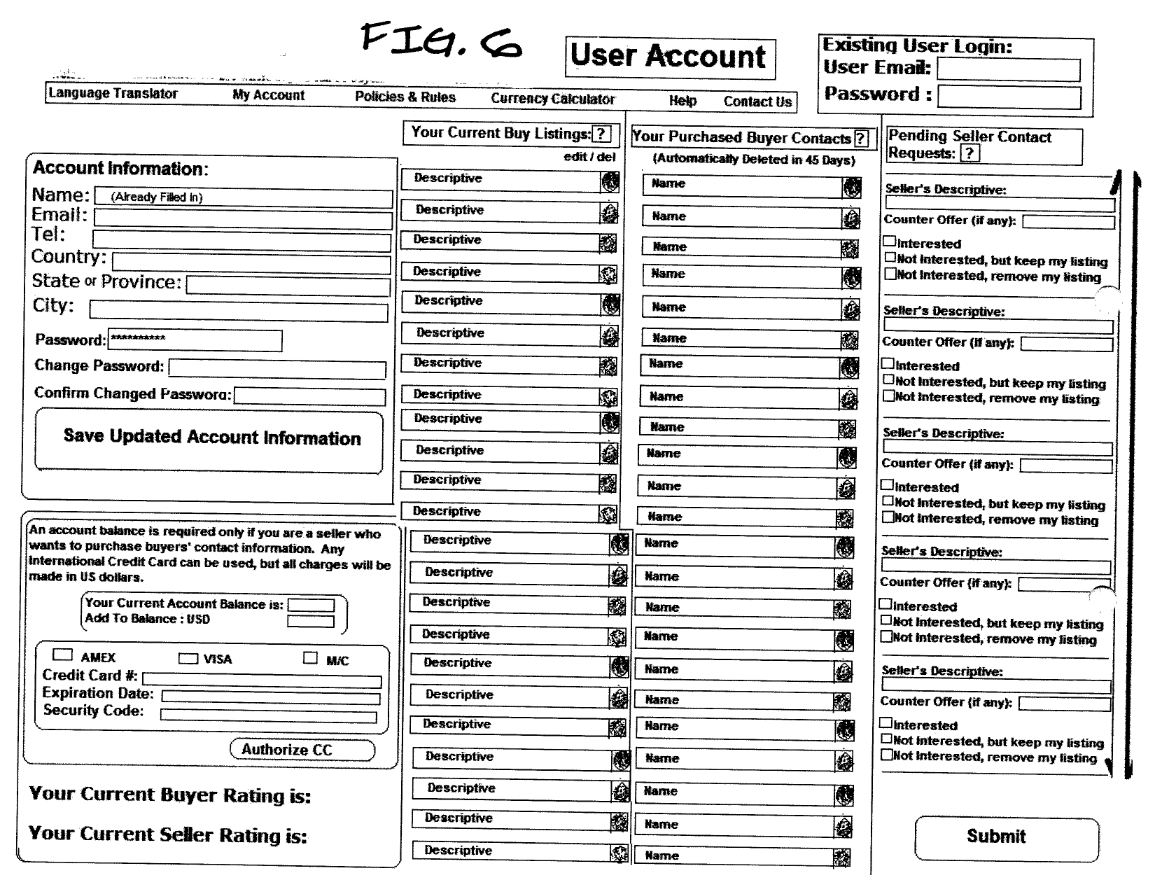

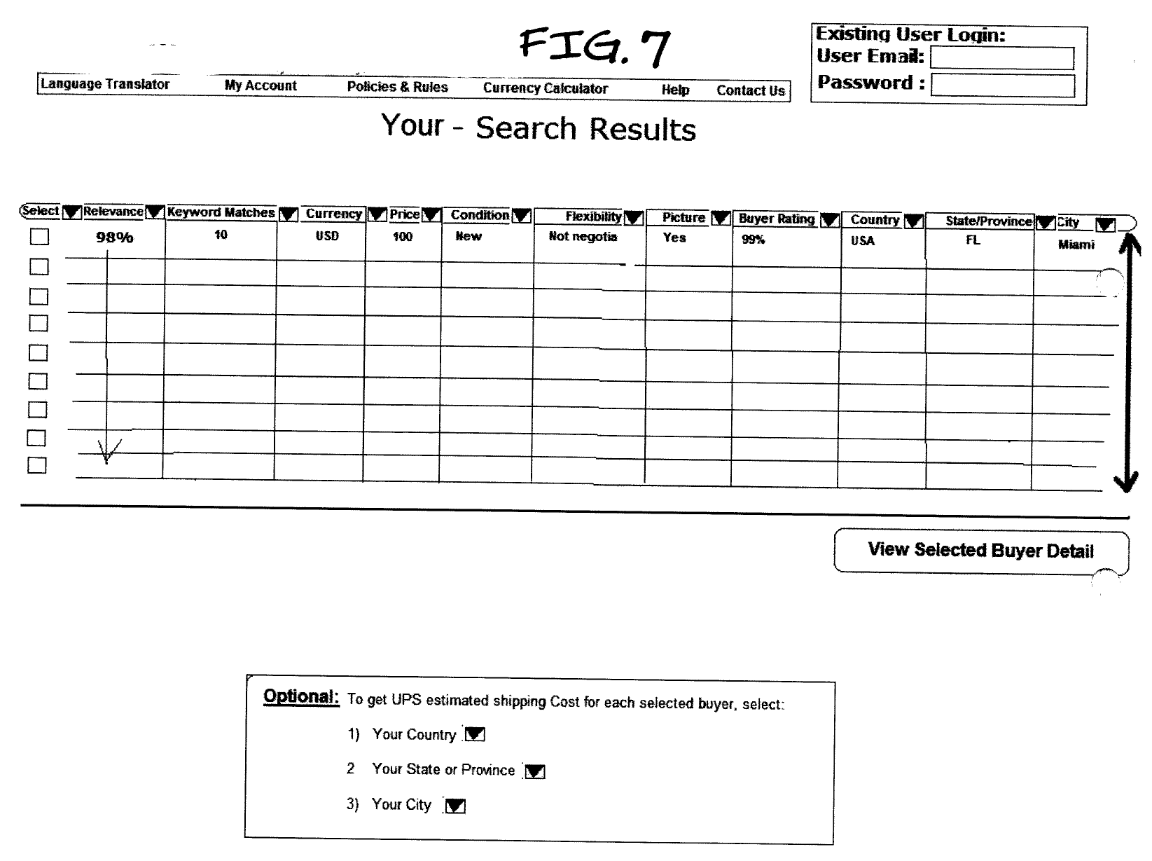

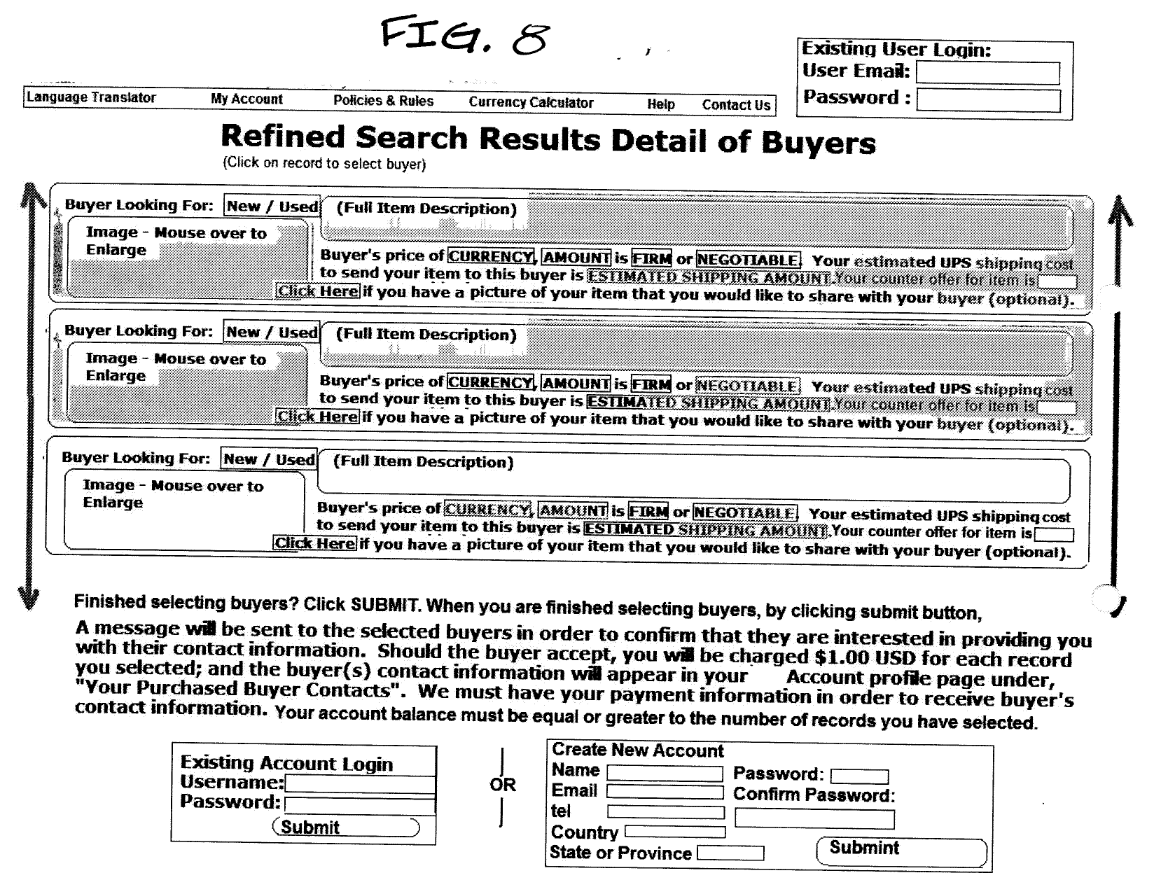

In this Example, a system 100 is constructed in which the Internet website causes a screen along the lines of FIG. 5 to display to a buyer B1 and seller S1 as a homepage; a screen along the lines of FIG. 6 to display as a user account page to a buyer B1 and/or a seller S1; a screen along the lines of FIG. 7 to display as a Search Results screen to a seller S1; and a screen along the lines of FIG. 8 to display to a seller S1 as a Refined Search Results Detail of Buyers website page.

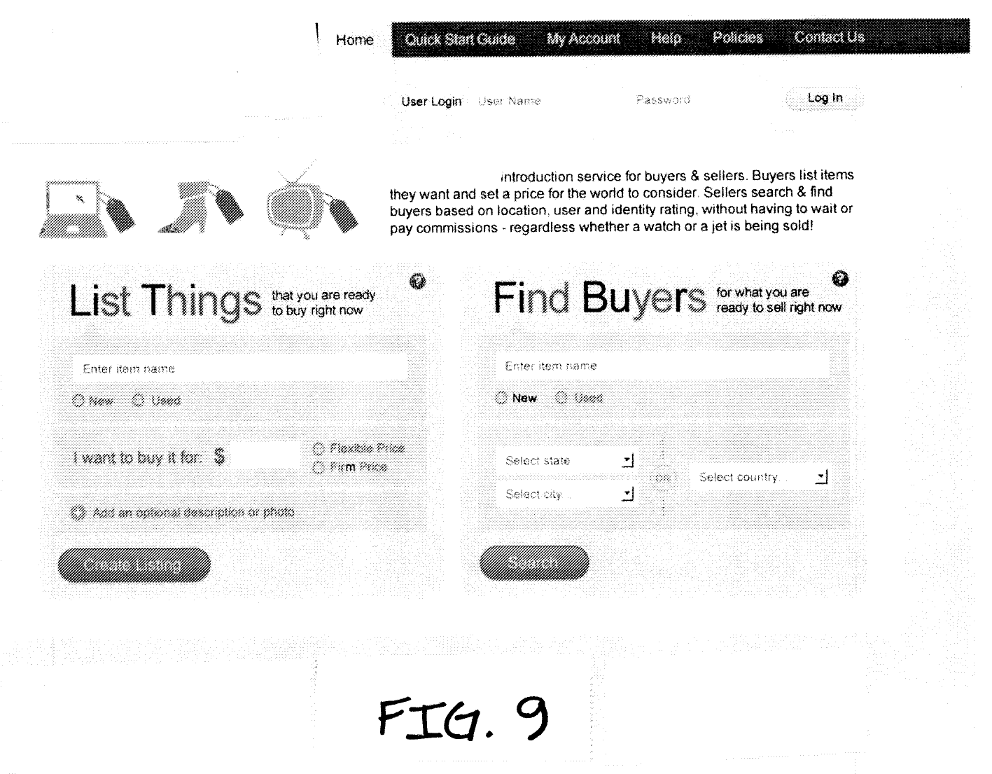

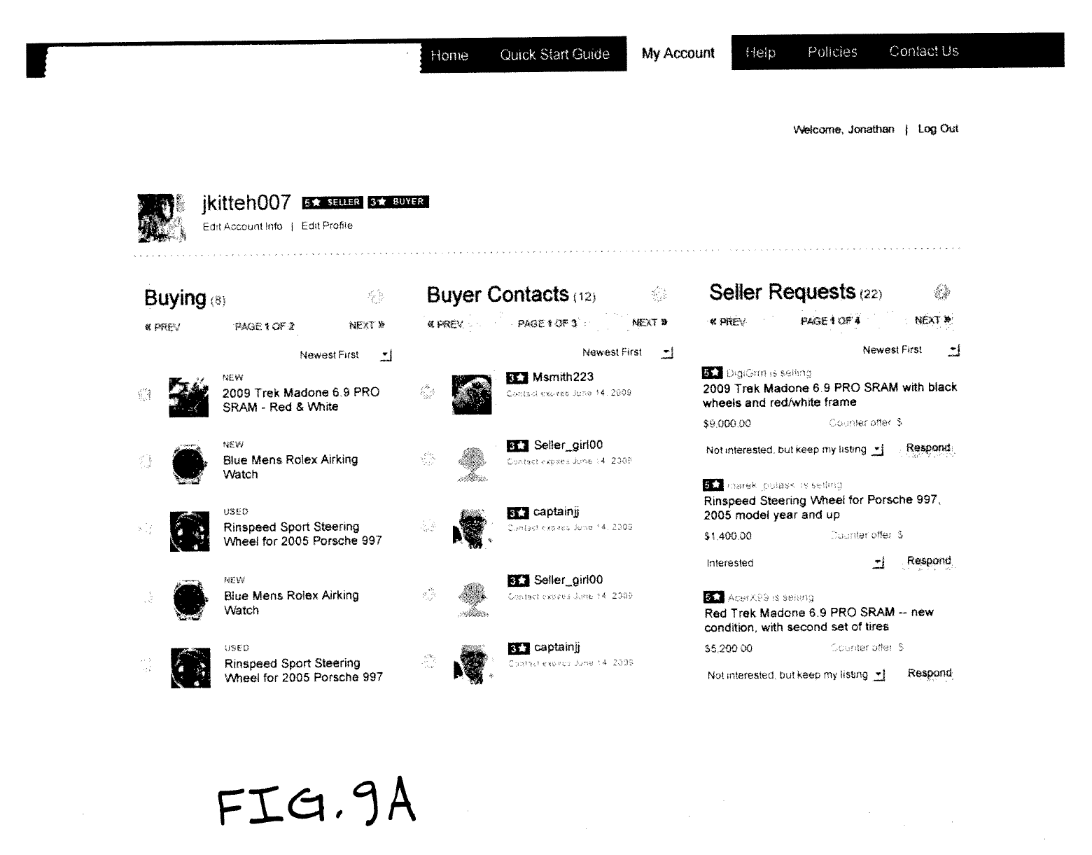

In this Example, once a seller S1 has selected a buyer B1 and hit a submit button, an email is sent to the buyer B1 such as an email along the lines of FIG. 9 which is an example of a message that may be sent by system 100 to a buyer B1 about a seller S1 to whom the buyer B1 has not yet been introduced.

In this Example, a buyer B1 who receives a message such as FIG. 9 indicating that a seller S1 wants to contact the buyer B1 must take further action in order to bring about an introduction and direct communication 111 with the seller S1, such as, e.g., logging into a user account of the buyer B1 and inputting a response into system 100 that instructs system 100 to make the introduction. Once the buyer B1 who has received a message from system 100 along the lines of FIG. 90 indicating that seller S1 wants an introduction, inputs into system 100 instruction for system 100 to proceed to make the introduction, system 100 contacts the seller S1, such as system 100 sending an email along the lines of FIG. 9A to the seller S1.

### EXAMPLE 2

Advantageously, inventive methods and systems may be used by a seller who is thinking of selling an item (such as, e.g., his snowboard), to, by referring to a website according to the invention, obtain nearly an instant answer (such as within a matter of a few seconds) of whether anyone is interested in buying your item that you wish to sell.

In the event that the seller's search returns one or more buyers, the Seller has the option to click “Select Buyer” which, when clicked, causes an email to go to the Buyer indicating that someone wants to sell to the Buyer. The Buyer who receives the email indicating the availability of a seller may respond affirmatively and accept the introduction, and if so, that is when the Buyer's contact information is released to the Seller and the website charges for the introduction (such as charging the Seller $1.00 for the introduction).

### EXAMPLE 2A

In this Example, hardware is as follows:

a dedicated server (such as with godaddy.com or another ISP);

2×120 GB disk drive;

500 GB bandwidth;

2 GB RAM;

Linux: CentOS or Fedora;

Plesk 30-domain control panel.

In this Example, the data is stored on a MySQL database and contains various tables which house the specific information related to each module of the website. Initially the MySql database resides on the same server as the website unless further testing warrants a separate server for database storage.

In this Example, all data resides on the same server. The website is built using the PHP language. Most of the graphics and layout documents are stored within the root directory of the web server. Sensitive data (e.g., usernames/passwords) are stored within the database using AES128 bit encryption for security. Although a transaction exists for each online purchase, no financial data is permanently stored.

### EXAMPLE 2B

### Instructions to Buyer-Users

In this example, a website within an inventive system 100 includes instructions to the buyer instructing the buyer to:

“List (free of charge) what product, service or experience you are looking for”, noting that “the more details you provide (ex., brand, model, color, size, etc.), the better match you will attract. If possible, upload photo of what you are seeking.”

“Your listing MUST NOT contain unlawful, discriminatory and/or pornographic material. Links, ads, cross marketing, link referral postings or programs are also NOT allowed.”

“DO NOT include your contact information in your listing. Doing so will result in your being banned from this website.”

“List the price you are willing to pay. Be reasonable. If you select “Firm” on your price, Sellers will not contact you unless they are ready to pay exactly the price you listed.”

“We will notify you via email to ask if you are still interested in a particular item when a Seller selects your listing. Upon your confirmation, we will release your contact information to the Seller. Our service is complete at this point.”

“Should Buyer and Seller wish to enter into a transaction on their own accord, we recommend using <<PayPal link>> to secure payment between them.”

### EXAMPLE 2C

### Instructions to Seller-Users

In this example, a website within an inventive system 100 includes instructions to the seller instructing the seller to:

“Search (free of charge) for the product, service or experience you desire. The more details you provide (ex., height, length, year, etc.), the better match you will attract. Assume you are paying shipping unless Buyer is negotiable.”

“Narrow down your results from the different criteria available (buyer rating, location, price, etc.) and select your desired Buyer(s). DO NOT select buyers who are FIRM on their price hoping to negotiate with them (“FIRM” means Buyers are not interest in negotiating their listed price.)

“We will contact Buyer(s) to confirm interest in item.”

“A $1 introduction fee will be charged for each confirmed Buyer you select (you must have equal or greater balance in account.)”

“Should Buyer and Seller wish to enter into a transaction, we recommend using <<PayPal link>>.”

### EXAMPLE 2D

### Emails Sent by the System

An example of an email message that may be sent by system 100 to a buyer about a seller to whom the buyer has not yet been introduced is as follows: “Dear Buyer, A seller would like to contact you regarding the <<Main Descriptive>> you have listed on <<Website Name>>. Please log into your account in order to see their Detail Request and determine what you would like to do.” An example of an email message that may be sent by system 100 to a seller when a buyer has accepted the introduction to the seller is as follows: “A buyer you selected has accepted your contact request for <<Main Descriptive>> you have listed on <<Website Name>>. You may log into your account to get their contact information. Please note that your contact purchases will remain in your account for 45 days, and then will be deleted. Good luck with selling your item and please consider using <<Pay Pal>>to collect your funds when you sell your item.”Optionally, an email message sent by system 100 to a Buyer or a Seller may include a translation button that when selected by a user translates an email into another language.

### EXAMPLE 2E

### Webpages

FIGS. 5-8 and FIGS. 9-9C are exemplary web pages for use in practicing the invention.

### Example 3

### Scoring Algorithm

A scoring algorithm for use with a website according to the invention is as follows. The scoring algorithm of this Example is based on a predetermined list of questions each having a score between 1 (lowest) and 5 (highest), with the history of this feedback being stored permanently in the database and referenced each time in order to calculate a user's total score, and with totals calculated on-the-fly based on the entire feedback history for that user so that an accurate score is displayed.

### EXAMPLE 3A

### Identity Rating with Separate Score

An Identity Rating is calculated as a separate score from the score of the Scoring Algorithm of Example 3.

### EXAMPLE 3B

### Identity Rating and User Rating Combined into a Score

An Identity Rating is calculated as part of the Scoring Algorithm of Example 3.

### EXAMPLE 3C

### 5-Stage Identity Rating

In this Example, an inventive system (such as system 100 in FIG. 1) sets a user's baseline Identity Rating at zero within a data storage table for the email address that the user is using along with at least the Actual Name that user has provided to the system. Optionally the system 100 also may receive as input from the user whose identity is to be subjected to Identity Rating, in addition to his Actual Name, also one or more of: his address; a government-recognized identification number associated with the user (such as, e.g., a social security number; a law license identification number; etc.); a government-recognized identification number associated with a possession of the user (such as, e.g., a vehicle identification number for a vehicle owned by the user; a license plate for a vehicle registered to the user; etc.); etc.

The system increases the user's Identity Rating to one if and only if, for the Actual Name that the user has provided to the system, the system has received uploaded information from the user that contains the same name given by the user.

The system increases the user's Identity Rating to two if and only if, for the Actual Name that the user has provided to the system, the system has received information maintained by a third party who is not the user, such as a website.

The system increases the user's Identity Rating to three if and only if, for the Actual Name that the user has provided to the system, the system has received information maintained in government records or a government database.

The system increases the user's Identity Rating to four if and only if, for the Actual Name that the user has provided to the system, the system has received biometric-based validation.

The system increases the user's Identity Rating to five if and only if, for the Actual Name that the user has provided to the system, the system has received confirmatory input that a personal verification (such as a personal verification performed by a licensed Notary) has been performed. The system may create a record of the name of who performed the personal verification, the date on which the personal verification was performed, and the place at which the personal verification was performed, and in a database associate the record with the Actual Name.

### Example 3D

### Linking to Social Networking Sites

In this inventive Example, a system 100 includes a linkage to one or more social networking sites which linked social networking site information is drawn into a profile of a buyer or a seller, with the profile being viewable by an opposite party after the buyer-seller introduced has been purchased by the seller and thus information is released to the seller. After the seller has paid for the buyer-seller introduction (which introduction the buyer has previously authorized), the seller can view the buyer's network and vice versa.

### EXAMPLE 4

### Guideline Tables

The invention may be practiced with or without the use of Guideline Tables. A Guideline Table gives a Buyer direction, if such direction is available, about whether the price that he is indicating that he would pay for a target item is realistic. For example, many Buyers probably would like to buy a genuine Rolex watch that they have seen in a store for $10,000 for a fraction of that amount, but there is little to be gained by having a Buyer post his willingness to buy a certain Rolex watch for, say, $100 or even $1,500 if the business operating the website is aware that the particular watch would be unlikely to be sold for less than $6,500. A price indication by a Buyer may be automatically processed against a Guideline Table, if a Guideline Table is available for the item, and if the price that the Buyer has entered is below the values in the Guideline Table, the entry may be refused for posting to the website, or a message may be sent to the Buyer that his price that he wants to post is unrealistic, or a combination thereof.

### EXAMPLE 5

### Listing an Experience

In this Example, a website according to the invention in-takes a Buyer's description for a target item which is an experience. The website optionally also in-takes a Buyer's description for a target item which is other than an experience (which Buyer's description for a target item which is other than an experience may be received via the same, or different, intake field as the intake field for a Buyer's target item which is an experience). Along with the Buyer's description for the experience, the website also in-takes at least the price that the Buyer is willing to pay for the experience.

An example of an experience for which a Buyer's description is in-taken is an experience of having a lunch meeting with a person whose name is mentioned by the Buyer in the description provided by the Buyer and in-taken by the inventive system in this Example. Another example of an experience for which a Buyer's description is in-taken is a space travel experience; a trail ride experience in a specific place; a fishing experience in a specific place; a private guided tour of a specific place; a lecture by a specific person; a private showing of specific artwork; coaching or instruction by a specific person, etc.

In this Example, an entry including the description of the experience wanted by the Buyer and the price that the Buyer is willing to pay is generated by the automated system and is posted on the website for public viewing. The Buyer's identity is not available for public viewing on the website.

### EXAMPLE 5A

### Charitable Fund-Raising

A charity may view a Buyer's description on the website and recognize that the charity may be able to arrange for the experience wanted by the Buyer (such as if the description mentions a celebrity who is on the charity's board of directors or otherwise affiliated with the charity) and therefore raise funds for the charity.

### EXAMPLE 6

### Time Passed on Seller Side

Comparative Example. A seller who has a specific item that he wants to sell uses the Ebay website by entering information about his to-be-sold item, which entry is then posted to the Ebay website as either a entry that is available for immediate purchase at a price set by the seller or an auction item, or a combination thereof. In either event, time passes on the seller's side while the seller must wait to see what, if any, interest is shown in his offered item. The Ebay seller of an auction item may see that his item is being viewed, but without a bid being placed yet; it is not uncommon for bidding activity to occur only near the final hours of an auction which might be seven days after the seller posted the item. Moreover, the seller's Ebay listing may expire without any bid having been placed. Whatever the ultimate outcome of the seller's posting of an item, the seller does not achieve immediate satisfaction (or indeed, any useful information) within seconds of posting his item.

Inventive Example. A seller who has a specific item that he wants to sell uses an inventive website such as a website included within a system 100 (FIGS. 1, 16) by entering a search term (or combination of search terms) into a field provided on the website to receive a seller's search query. The seller obtains immediate satisfaction within seconds of entering his search query: he either learns that no results are returned matching his search query, or, he has available for immediate viewing one or more search results matching his search query and which reflect buyers who want to buy his item that he wants to sell.

### EXAMPLE 6A

### Seller-Side Saved Search

In this inventive Example 6A, a system 100 provides for a seller to be able to save a seller's search query, such as if no buyers are available at the time that the seller searches, and for a saved search, for the seller saving the search to be notified later by email if a buyer lists a good that meets the seller's relevant key words to whatever percentage match the seller has specified (e.g., the seller can set a feature that the system 100 will contact the seller if a buyer lists something that matches 75% of the listing that the seller saved).

### EXAMPLE 7

### Buyer's Price as a Mandatory Field

In this Example, the inventive system (such as system 100) is configured to require that a price appears in a price field in-taken from the buyer before the system will process the buyer's description and post an entry onto the website viewable by sellers. In this Example, a price field that is in-taken from the Buyer is constructed as a mandatory field that must be filled-in by the Buyer in order for the description field that the Buyer has filled-in for the item that the Buyer wants to buy can be processed by the system 100 and posted onto a website within the system 100.

### EXAMPLE 8

### Global Reach

Comparative Examples: Craigslist is used by buyers and sellers, and is local in nature. Ebay is used by buyers and sellers, and is essentially national. On Ebay, certain seller groups have succeeded in cornering items such as diamonds and luxury watches, with relatively effective seller-side control of pricing.

Inventive Example. A website used in an inventive system such as system 100 has a global reach. The global aspect provides relatively more opportunities for greater deals for buyers and sellers (i.e., buyers list and sellers search for buyers, globally in their own respective currencies) compared to approaches with local (e.g., Craigslist) or national (e.g., Ebay) reach. A retailer or other seller has a more difficult time to control pricing in an inventive system such as system 100 which has a global basis. Better deals for individual buyers are possible for buyers using the inventive system 100 compared to using Craigslist or Ebay. A seller can access a global selection of qualified buyers that can be sorted by city, state/province, country, or the entire planet.

### EXAMPLE 9

### Seller-Side Privacy/Anonymity/Control

Comparative Example. When an Ebay seller lists an item on Ebay, it is out of his hands whether anyone will recognize his Ebay user name or infer his identity from his posted information including his geography when he may prefer greater privacy or anonymity. It is out of his hands which buyer, if any, will buy his item. It is out of his hands whether, in the case of a distinctive item, anyone would recognize the item and associate the posting with him. Moreover, Ebay essentially automatically picks the buyer for the seller based on price, without permitting the seller to exercise his own judgment including use of one or more non-price factors.

Inventive Example. An item's owner, no matter how famous or jealous of his privacy he is, can search, in complete privacy, on a website that is part of inventive system 100 to see if anyone has listed wanting to buy his item. If his search returns one or more listings by buyers, he remains in control of deciding whether or not he wants to proceed to be introduced to one, or more, of the posters who are buyers. The seller using the website within system 100 remains in control over which buyer he picks to complete the transaction that he has researched, or no buyer. Moreover, the seller who is introduced to a buyer thanks to system 100 is not obligated by the system 100 to complete a sales transaction with the buyer to whom he has been introduced.

### EXAMPLE 10

### Multi-Lingual Use

In this Example, language is used as a natural sorting factor, and users of an inventive website may cover a full gamut of languages served by computer keyboards and input devices such as languages using a Roman alphabet (such as English, French, Italian, Spanish, etc.), Chinese, Japanese, Korean, languages using a Syrilic alphabet, Greek, etc. In this Example, system 100 includes one website which receives input from users working in a full spectrum of languages, with each user entering input in the language that his computer keyboard produces. The system 100 receives a Seller-input search query and searches against entries generated from input received from Buyers. Entries generated from Buyer input using language characters or alphabet different from that used by the Seller will not match the Seller's search query and will not be returned to the Seller. For example, system 100 receives a first Seller's search query via the website using a Japanese-character keyboard, and returns only Japanese-character search results to the first Seller. Meanwhile, system 100 receives via the same website a second Seller's English-language search query, and returns to the second Seller only English-language search results. The system 100 matches buyer-seller pairs who are working in the same language as each other. The system 100 generally will not match buyer-seller pairs who are working in different languages from each other even if the same alphabet is used across the languages (such as the same alphabet being used in English, French, Spanish and Italian), because the respective languages generally will have non-identical words for the same object.

### EXAMPLE 10A

In this Example, an inventive system 100 processes a user's URL and/or email address to ascertain the country associated with the user, and displays the website to the user in the language associated with that country.

It will be appreciated that variations and modifications from the embodiments set forth above may be made without departing from the spirit of the invention, and that such modifications are to be considered within the present invention.

1. A method of introducing at least one Buyer to at least one Seller, comprising the steps performed by an automated system of:
via a website viewable by the Buyer and the Seller, in-taking from the Buyer, in computer-readable form, at least a description of a target item and a price that the Buyer is willing to pay for the target item;
generating an entry for the target item of the Buyer, and posting the entry on the website;
introducing the Buyer to the Seller;
wherein the in-taking, generating, posting and introducing steps are performed by one or more of: a computer, a computer processor, a computer network, a machine or another non-human instrumentality, or a combination thereof.

2. The method of claim 1, including steps performed by the automated system and before the introducing step of:
via the website, in-taking a search query that was input by the Seller at an input time; and
returning to the Seller, within seconds of the input time, a list comprising the entry for the target item of the Buyer or a link thereto and, optionally, comprising one or more further entries or further links to entries respectively generated from a plurality of Buyers.

3. The method of claim 1, further comprising, for a claimed identity of a party who is the Buyer or the Seller in-taken by the website as input from the party, cross-referencing the claimed identity.

4. The method of claim 1, further comprising a step, also performed by the automated system, of computing an Identity Rating for at least one of the Buyer and the Seller.

5. The method of claim 4, including:
computing an Identity Rating for the Buyer,
computing an Identity Rating for the Seller,
displaying to the Buyer the Identity Rating for the Seller, and
displaying to the Seller the Identity Rating for the Buyer.

6. The method of claim 5, wherein the computing of the Identity Rating includes processing cross-reference data from at least a first source and a second source, the first source representing information on the Internet that the user being rated may self-post or information that the user being rated may upload, and the second source representing information on the Internet not self-posted by the user being rated.

7. The method of claim 6, further including a step performed by the automated system of receiving, in machine-readable form, input relating to verification that is physically-based and/or in-person by a Notary or other verifier, with regard to an identity of the user for whom an Identity Rating is being computed, followed by computing the Identity Rating using the received input relating to verification.

8. The method of claim 5, further comprising displaying the computed Identity Rating for a party to an opposite party.

9. The method of claim 1, including repeating the Buyer-Seller introducing step for a plurality of Buyer-Seller introductions, wherein the website operates on a global basis and the Buyer-Seller introductions are on a global basis.

10. The method of claim, including the website's in-taking, from a plurality of respective Buyers, descriptions for target items in a plurality of languages and/or alphabets, while also in-taking; from a plurality of respective Sellers, search queries in a plurality of languages and/or alphabets.

11. The method of claim 1, including, receiving as input from the Buyer a photograph, and optionally a comment regarding price flexibility and/or location of the Buyer and/or other comment.

12. The method of claim 1, including, after charging the Seller, introducing the Buyer to the Seller including providing to the Seller a contact information for the Buyer.

13. The method of claim 1, including a step of collecting compensation before the introducing step.

14. The method of claim 13, wherein the in-taking from the Buyer the description of the target item and the price, and generating the entry and posting the entry are performed without being conditioned on collecting compensation from the Buyer or the Seller,
and further including a step by the automated system of providing access to the Seller to view the posted entry for the target item without providing access being conditioned on collecting compensation from the Buyer or the Seller,
and further including steps performed by the automated system of in-taking from the Seller an indication of the Seller's interest in the Buyer and transmitting to the Buyer a message indicating the Seller's interest in the Buyer without the in-taking from the Seller or the transmitting to the Buyer being conditioned on collecting compensation from the Buyer or Seller,
and further including steps performed by the automated system of in-taking from the Buyer a reply to the message indicating the Seller's interest and transmitting the Buyer's reply to the Seller without the in-taking from the Buyer or the transmitting the Buyer's reply being conditioned on collecting compensation from the Buyer or Seller.

15. The method of claim 1, including an in-taking step in which the target item is selected from the group consisting of a product; a service; an experience; real estate; an animal; intellectual property; and a business.

16. The method of claim 1, including, without charge to the Seller:
receiving a search query from the Seller,
processing the Seller's search query and
returning to the Seller, search results for at least the Buyer in which a location for each Buyer is displayed in the search results returned to the Seller.

17. The method of claim 1, including, without charge to the Seller, saving, in a database, a search query input by a Seller to which search query no entry for a target item of a Buyer was returned, followed by computer-based processing of the saved search query in the database against newly-in-taken Buyer entries, and, if the processor determines that a new Buyer entry is responsive to the Seller's saved search query, automatically notifying the Seller of the new Buyer entry optionally including notifying of a percentage match of the new Buyer entry vis-a-vis the Seller's saved search query.

18. The method of claim 1, including performing the steps of in-taking from the Buyer the description of the target item and the price, generating and posting the entry on the website, and introducing the Buyer to the Seller, without charging the Buyer.

19. The method of claim 1, including posting an entry that includes a geographical location of the Buyer.

20. The method of claim 1, including, before the introducing step and performed by the automated system: in-taking from the Seller a query associated with the entry for the target item whether the Buyer is still interested, transmitting a confirmatory query to the Buyer for the target item about which the Seller has in-put the query whether the Buyer is still interested, receiving a reply from the Buyer to the confirmatory query, and based on the reply from the Buyer to the confirmatory query, transmitting a message to the Seller indicating whether the Buyer has been confirmed to be still interested.

21. An Internet-based method of introducing a Seller to a plurality of Buyers, comprising:
on a website, in-taking from each Buyer of a plurality of Buyers, in computer-readable form, at least a description of a target item along with a price that the Buyer is willing to pay for the target item;
from the description of the target item and the price, creating, by operation of a processor, a computer-generated postable entry;
conditioning an introduction of the Buyer to the Seller until an event compensating a business entity associated with the website has occurred.

22. The method of claim 21, including steps performed by the automated system and before the introducing step of:
via the website, in-taking a search query that was input by the Seller at an input time; and
returning to the Seller, within seconds of the input time, a list comprising the entries for the respective target items of a quantity of Buyers or links thereto.

23. The method of claim 21, further comprising, for a claimed identity of a party who is the Buyer or the Seller in-taken by the website as input from the party, cross-referencing the claimed identity.

24. The method of claim 21, wherein the steps are performed by an automated system which further performs a step of computing an Identity Rating for at least one of the Buyer and the Seller.

25. The method of claim 21, including steps of processing a search by the Seller in which a search term used by the Seller is processed by a processor to connect with the target item;
in response to the search by the Seller returning a set of search results including a plurality of Buyers having an entry based on the target item; and
introducing the Seller to at least one Buyer.

26. An Internet-based buyer-seller introduction system, comprising:
a website including at least one input area configured to receive from a Buyer at least: (1) a description of a target item and a price that the Buyer is willing to pay for the target item;
a computer-implemented entry-creator that, from the description of the target item and the price that have been received in the at least one input area, creates a postable entry;
a computer-implemented contact information manager that (1) associates a contact information for the Buyer with the entry; and (2) maintains the contact information for the Buyer in confidence until a Compensation-to-the-introduction-service Event has occurred;
a computer-implemented posting manager that posts the entry to the website.

27. The system of claim 26, wherein the website comprises at least one area configured to receive from a Seller a search query, and the system includes a Seller Search Query processor that processes the Seller's search query input and outputs onto the website a set of search results for viewing by the Seller within seconds of a time when the Seller input the Seller's search query.

28. The system of claim 26, including an automated Cross-Referencer that, for an input which is a claimed identity of a party who is the Buyer or the Seller in-taken by the website as input from the party, cross-references the claimed identity.

29. The system of claim 26, including a message generator that generates a message, viewable by a Seller who is using the website, indicating how many previous responses have been sent to the Buyer, before the Seller takes action to incur a charge to be introduced to the Buyer.

30. The system of claim 26, further comprising an automated system that computes an Identity Rating for at least one of the Buyer and the Seller and that displays the computed Identity Rating for a party to an opposite party.

31. A method of introducing at least one Buyer to at least one Seller, comprising the steps performed by an automated system of:
via a website viewable by the Buyer and the Seller, in-taking from the Buyer, in computer-readable form, at least a description of a target item and a price that the Buyer is willing to pay for the target item;
generating an entry for the target item of the Buyer, and posting the entry on the website;
computing an Identity Rating for at least one of the Buyer and the Seller and maintaining the computed Identity Rating in a database as a displayable Identity Rating, the displayable Identity Rating being updatable;
re-computing the Identity Rating and updating the displayable Identity Rating in the database to be the re-computed Identity Rating;
introducing the Buyer to the Seller;
wherein each step is performed by one or more of: a computer, a computer processor, a computer network, a machine or another non-human instrumentality, or a combination thereof.

32. The method of claim 31, further comprising displaying the displayable Identity Rating for at least one of the Buyer and the Seller to an opposite party who is being introduced or has been introduced to the party for whom the Identity Rating was computed.

33. The method of claim 31, including computing the Identity Rating by, for a predefined first condition, ascertaining that the first condition exists, and maintaining in the database a displayable Identity Rating equal to a first value.

34. The method of claim 33, including re-computing the Identity Rating by, for a predefined second condition, ascertaining that the second condition exists, and maintaining in the database a displayable Identity Rating equal to a second value which is greater than the first value.

35. The method of claim 33, including repeating the re-computing the Identity Rating by, for a predefined third condition, ascertaining that the third condition exists, and maintaining in the database a displayable Identity Rating equal to a third value which is greater than the second value.

36. The method of claim 35, including a re-computing step that includes ascertaining that a condition exists of an individual verifier having verified, in-person, that the Buyer or the Seller who is the subject of the Identity Rating is as claimed, and maintaining in the database a displayable Identity Rating equal to a highest value of a set of values which the Identity Rating may take.

37. An automated seller-side research method, comprising:
via a website, in computer-readable form, in-taking a search query for a target item being researched by a Seller, the Seller's search query having been input by the Seller at an input time; and
within seconds of the input time, returning to the Seller a search result, wherein the search result includes: an entry generated from a description of a target item that was in-taken by the website from a Buyer along with a price that the Buyer is willing to pay that was in-taken by the website from the Buyer, or a link to said entry.

38. The method of claim 37, including, via the website, in-taking from the Buyer, in computer-readable form, at least the description of a target item and the price that the Buyer is willing to pay for the target item.

39. The method of claim 37, including a step, performed by a processor, of processing the Seller's search query against a database containing a plurality of entries generated from machine-readable data in-taken via the website when input by a plurality of Buyers, each entry being associated with a respective Buyer and having a respective target item of a Buyer and a price that the Buyer is willing to pay for the target item associated with the entry.

40. A method of rating an identity claimed by an on-line user, comprising the steps performed by an automated system of:
for the on-line user who has claimed the identity to the automated system, computing an Identity Rating and maintaining the computed Identity Rating in a database as a displayable identity Rating, the displayable Identity Rating being updatable;
re-computing the Identity Rating and updating the displayable Identity Rating in the database to be the re-computed Identity Rating;
wherein each step is performed by one or more of: a computer, a computer processor, a computer network, a machine or another non-human instrumentality, or a combination thereof.

41. The method of claim 40, further comprising displaying the displayable Identity Rating for the on-line user to an opposite party.

42. The method of claim 40, including computing, performed by a processor, the Identity Rating by, for a predefined first condition, ascertaining that the first condition exists, followed by maintaining in the database a displayable Identity Rating equal to a first value.

43. The method of claim 40, including re-computing, performed by a processor, the Identity Rating by, for a predefined second condition, ascertaining that the second condition exists, followed by maintaining in the database a displayable Identity Rating equal to a second value which is greater than the first value.

44. The method of claim 43, including repeating, performed by a processor, the re-computing the Identity Rating by, for a predefined third condition, ascertaining that the third condition exists, followed by maintaining in the database a displayable Identity Rating equal to a third value which is greater than the second value.

45. The method of claim 40, including a re-computing step, performed by a processor, that includes ascertaining that a condition exists of an individual verifier having verified, in-person, that the identity of the on-line user is as claimed, followed by maintaining in the database a displayable Identity Rating equal to a highest value of a set of values which the Identity Rating may take.

46. A method of introducing at least one Buyer seeking to obtain an experience to at least one Seller, comprising the steps performed by an automated system of:
via a website viewable by the Buyer and the Seller, in-taking from the Buyer, in computer-readable form, at least a description of a target item which is an experience and a price that the Buyer is willing to pay for the experience;
wherein the in-taking step is performed by one or more of: a computer, a computer processor, a computer network, a machine or another non-human instrumentality, or a combination thereof.

47. The method of claim 46, including generating an entry for the experience which is the target item of the Buyer, and posting the entry on the website, the steps of the method being performed by one or more of: a computer, a computer processor, a computer network, a machine or another non-human instrumentality, or a combination thereof.

48. The method of claim 46, including introducing the Buyer to the Seller, the steps of the method being performed by one or more of: a computer, a computer processor, a computer network, a machine or another non-human instrumentality, or a combination thereof.

49. The method of claim 47, wherein the in-taking step includes in-taking a description for an experience that would require participation or cooperation of at least one individual or business entity who or which at a time of the in-taking is not publicly offering, within a regular course of the individual or the business entity's business, a service which would correspond to the experience.

50. An Internet-based method for a Seller to pursue selling an item without needing to post an entry for the item, comprising:
via a website, in computer-readable form, in-taking a search query for a target item being researched by a Seller;
returning to the Seller a search result, wherein the search result includes: an entry generated from a description of a target item that was in-taken by the website from a Buyer along with a price that the Buyer is willing to pay that was in-taken by the website from the Buyer, or a link to said entry.

51. The method of claim 50, including a step, performed by a processor, of processing the Seller's search query against a database containing a plurality of entries generated from machine-readable data in-taken via the website when input by a plurality of Buyers, each entry being associated with a respective Buyer and having a respective target item of a Buyer and a price that the Buyer is willing to pay for the target item associated with the entry.

52. The method of claim 50, further comprising an automated step of introducing the Seller to the Buyer, wherein the Seller is introduced to the Buyer without the Seller having had to post an entry for the item.

53. The method of claim 1, including an in-taking step in which the description of the target item is in-taken through a first input box and the price is in-taken through a second input box which is distinct from the first input box.

54. The method of claim 53, comprising an in-taking step that includes in-taking, via an input which is distinct from the first input box and the second input box, whether the target item has a newness characteristic selected from the group consisting of “new”, “used”, and “new or used”.
